(19) United States
(12) Patent Application Publication
(10) Pub. No.: US 2010/0244716 A1
(43) Pub. Date: Sep. 30, 2010

(54) HIGH PRESSURE DISCHARGE LAMP BALLAST WITH ADAPTIVE FILAMENT HEATING CONTROL BASED ON LAMP AGE

(76) Inventors: Daisuke Yamahara, Shijounawate (JP); Naoki Komatsu, Kobe (JP)

Correspondence Address: WADDEY & PATTERSON, P.C., 1600 DIVISION STREET, SUITE 500, NASHVILLE, TN, 37203, US

(21) Appl. No.: 12/711,135

(22) Filed: Feb. 23, 2010

(30) Foreign Application Priority Data
Feb. 23, 2009 (JP) 2009-039649

(51) Int. Cl. H05B 41/36

(52) U.S. Cl. 315/224

(57) ABSTRACT

A high pressure discharge lamp ballast is provided with adaptive power control during a filament heating period. A starting circuit is coupled along with a high pressure discharge lamp to output terminals of a DC-AC power converter and generates a high voltage for dielectric breakdown in the lamp. A control circuit controls output power from the power converter to the lamp during the filament heating period after dielectric breakdown of the lamp. The output power is controlled in accordance with a power output parameter which is further determined by the control circuit in accordance with one or more lamp parameters detected by a lamp status detection circuit. The lamp parameters may be cumulative lamp parameters or electrical characteristics associated with the lamp.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application claims benefit of the following patent application(s) which is/are hereby incorporated by reference: Japan Patent Application No. JP2009-039649, filed Feb. 23, 2009.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present invention relates to a high pressure discharge lamp ballast for powering a high pressure discharge lamp, an illumination fixture incorporating the ballast, and an illumination system constructed by a plurality of such illumination fixtures. More particularly, the present invention relates to a lamp ballast with adaptive filament heating control with regards to a cumulative lighting time of a high pressure discharge lamp.

Many high pressure discharge lamps with high luminance, also called HID (High-Intensity Discharge) lamps, have been commonly used, particularly for vehicles. Such lamps need to generate discharge in the lamp upon ignition and therefore require a ballast which generally includes a DC-AC power converter and a control circuit for controlling the power converter.

Certain high pressure discharge lamp ballasts as known in the art are provided with a number of operating modes or phases including: an ignition or startup period (hereinafter referred to as “phase 1”) for applying an increased peak voltage to a high pressure discharge lamp and causing dielectric breakdown for generation of arc discharge; a filament heating period (hereinafter referred to as “phase 2”) for increasing an AC frequency in the power converter to supply power that is equal to or higher than rated power to the high pressure discharge lamp and to heat the lamp filaments to a sufficient degree in a relatively short period of time; and a normal or steady-state period (hereinafter referred to as “phase 3”) for carrying out normal lamp operation by applying and maintaining rated AC power from the power converter to the high pressure discharge lamp.

However, while many previously known ballasts sufficiently heat the filaments for some specific high pressure discharge lamps, they are often insufficient for heating filaments in other high pressure discharge lamps of varying ages and physical characteristics.

FIGS. 35a and b show a waveform of lamp current obtained when the duration of phase 2 is varied in an experiment carried out using a high pressure discharge lamp ballast structured as stated above (an HCI-TC/E70W/NDL: manufactured by OSRAM).

As shown in FIG. 35a, where the duration of phase 2 is sufficiently long, the lamp current gradually flows to both filaments in a substantially uniform manner, which provides for transition to phase 3 after the formation of stable discharge.

In contrast, as shown in FIG. 35b, where the duration of phase 2 is relatively short, the waveform of the lamp current is not uniform with respect, to the filaments, resulting in a half-wave discharge state (e.g., rectification). Thus, the filaments cannot be heated sufficiently, and transition to phase 3 in this state makes the discharge extremely unstable, resulting in a possibility of the lighting becoming extinguished.

In general, high pressure discharge lamps at the end of their service life are difficult to start in comparison with new high pressure discharge lamps and easily suffer extinguishing, flickering, and other undesirable effects after transition to phase 3. This is at least partly because high pressure discharge lamps at the end of their service life insufficiently heat the filaments in phase 2 and proceed to phase 3 in a half-wave discharge state.

Defective lamp startup is also caused by contaminating impurities that occur in the lamp manufacturing. For example, if an impurity such as water enters a lamp in the manufacture process, the water impurity forms an oxide with an inclusion (a metal) of the lamp, resulting in gaseous impurities such as hydrogen and iodine as shown in the following chemical equations 1 to 3, and which capture electrons or in other words siphon off energy from the excited filling gas atoms that would otherwise contribute to discharge.

[Chemical equation 1]

3H₂O+2Tm(Ho,Dy)I₃ [symbol] 3H₂+Tm₂(Ho,Dy)O₃+3I₂ (1)

[Chemical equation 2]

I₂+2e⁻ [symbol] 2I⁻ (2)

[Chemical equation 3]

HI+e⁻ [symbol] (HI)* [symbol] H+I⁻ (3)

Such impurities may therefore easily cause unstable discharge because they degrade the ability of the lamp to ignite by requiring a higher voltage to maintain discharge. Moreover, the amount of contaminating impurity resulting from the manufacturing process varies with each high pressure discharge lamp, which means that the abilities of the high pressure discharge lamps to start also vary with each lamp.

To simply resolve these problems, the duration of phase 2 may be increased or alternatively the value of the lamp current in phase 2 may be increased, thereby ensuring sufficient filament heating for any high pressure discharge lamp.

However, if these solutions are applied uniformly to all high pressure discharge lamps, excessive filament heating occurs in high pressure discharge lamps that are in an early stage of use and in high pressure discharge lamps with only small amounts of contaminating impurities, raising the possibility of defects such as shortened lamp life that could otherwise have been avoided.

Another possible method as known in the art includes detecting a current through and/or voltage across a high pressure discharge lamp in phase 2, and upon determining that the detected current and/or voltage is not substantially uniform in the positive and negative polarities (symmetrical), heating both filaments uniformly by adjusting the current supplied to the high pressure discharge lamp. According to this method, a substantially uniform lamp current is provided in an early stage of phase 2 and stable discharge is formed at the time of transition to phase 3.

However, the above method requires a detection circuit and a control circuit of undesirable complexity, resulting in increased costs due to an increase in the number of components.

### BRIEF SUMMARY OF THE INVENTION

In accordance with the present invention a high pressure discharge lamp ballast is provided for an illumination fixture, or an illumination system with a plurality of fixtures, that has adaptive control capabilities for necessary and sufficient filament heating, thus forming stable discharge without complicating the circuit structure.

In an embodiment, a high pressure discharge lamp ballast is provided with adaptive power control during a filament heating period. A starting circuit is coupled along with a high pressure discharge lamp to output terminals of a DC-AC power converter and generates a high voltage for dielectric breakdown in the lamp. A control circuit controls output power from the power converter to the lamp during the filament heating period after dielectric breakdown of the lamp. The output power is controlled in accordance with a power output parameter which is further determined by the control circuit in accordance with one or more lamp parameters detected by a lamp status detection circuit. The lamp parameters may be cumulative lamp parameters or electrical characteristics associated with the lamp.

In another embodiment, a method of adaptive filament heating control is provided for a high pressure discharge lamp ballast which includes an inverter, a lamp parameter detection circuit, and a control circuit effective to control a power output from the inverter to a high pressure discharge lamp. The method includes a first step of reading a cumulative lamp parameter from the lamp parameter detection circuit which is either a cumulative lighting time for the lamp or a cumulative lamp ignition count. A second step of the method is setting a power output parameter for the power converter based on the cumulative lamp parameter. A third step is controlling the power converter to provide an output power to the lamp corresponding to the power output parameter during the filament heating period, which begins after dielectric breakdown of the lamp. The method finally includes terminating the filament heating period and entering a steady-state period, wherein the control circuit controls the power converter to decrease an operating frequency and maintain a stable light output from the lamp.

In another embodiment of the present invention, an illumination system includes one or more illumination fixtures. Each illumination fixture is made up of a ballast housing containing a high pressure discharge lamp ballast and a lamp housing containing a high pressure discharge lamp. The lamp housing is mechanically coupled to the ballast housing and electrically coupled to the discharge lamp ballast. A control device is provided for controlling each of the one or more illumination fixtures. The lamp ballast further includes a DC-AC power converter, a lamp parameter detection circuit, and a control circuit effective to control the power converter. The control circuit determines a power output parameter to the high pressure discharge lamp in a filament heating period after dielectric breakdown of the lamp, wherein the power output parameter is determined in accordance with one or more lamp parameters detected by the lamp status detection circuit.

### BRIEF DESCRIPTION OF THE SEVERAL VIEWS OF THE DRAWINGS

FIG. 1 shows a circuit schematic of an embodiment of a high pressure discharge lamp ballast of the present invention.

FIG. 2 is a graphical diagram showing waveforms of driving signals as applied to the gates of each switching element in the ballast of FIG. 1.

FIG. 3 is a graphical diagram showing waveforms of a lamp voltage and a lamp current applied to a lamp in the ballast of FIG. 1.

FIG. 4 is a flowchart describing a starting sequence in the ballast of FIG. 1.

FIGS. 5a and 5b are graphical diagrams describing relationships between fixed and curved adjustments to phase 2 durations and a cumulative lighting time of a lamp in the ballast of FIG. 1.

FIGS. 6a and 6b are graphical diagrams describing relationships between fixed time and varied time adjustments to phase 2 durations and a cumulative lighting time of a lamp in the ballast of FIG. 1.

FIGS. 7a and 7b are graphical diagrams describing relationships between linear and curved adjustments to an upper limit of phase 2 durations and a cumulative lighting time of a lamp in the ballast of FIG. 1.

FIG. 8a is a graphical diagram showing a lamp current waveform for a new lamp in the ballast of FIG. 1, and FIG. 8b is a graphical diagram showing a lamp current waveform for a lamp at the end of its service life in the ballast of FIG. 1.

FIG. 9 is a circuit diagram showing another embodiment of a high pressure discharge lamp ballast of the present invention.

FIG. 10 is a graphical diagram showing driving signals applied to gates of the switching elements in the ballast of FIG. 9.

FIG. 11 is a circuit diagram showing another embodiment of a high pressure discharge lamp ballast of the present invention.

FIG. 12 is a graphical diagram showing driving signals applied to gates of the switching elements in the ballast of FIG. 11.

FIG. 13 is a flowchart describing an embodiment of a method of operation for the ballast of FIG. 1.

FIGS. 14a and 14b are graphical diagrams describing relationships between linear and curved adjustments to a lamp current value in phase 2 and a cumulative lighting time of the lamp in the ballast according to the method of FIG. 13.

FIGS. 15a and 15b are graphical diagrams describing relationships between fixed time and varied time adjustments to lamp current values in phase 2 and a cumulative lighting time of a lamp in the ballast according to the method of FIG. 13.

FIGS. 16a and 16b are graphical diagrams describing relationships between lamp current values in phase 2 and a lamp voltage in the ballast according to the method of FIG. 13.

FIGS. 17a and 17b are graphical diagrams showing a lamp current waveform for a new lamp using the method of FIG. 13, and a lamp current waveform for a lamp at the end of its service life using the method of FIG. 13.

FIG. 18 is a flowchart describing another embodiment of a method for operation of the ballast of FIG. 1.

FIGS. 19a and 19b are graphical diagrams describing linear and curved increases, respectively, in a current-time product in phase 2 with respect to the cumulative lighting time of a lamp using the method of FIG. 18.

FIG. 20 is a flowchart describing another embodiment of a method of operation for the ballast of FIG. 1.

FIG. 21 is a flowchart describing another embodiment of a method of operation for the ballast of FIG. 1.

FIG. 22 is a graphical diagram showing a lamp voltage waveform in phase 3 with respect to time according to the embodiment of FIG. 21.

FIG. 23 is a circuit diagram showing an embodiment of a restart voltage detection circuit in accordance with a ballast using the method of FIG. 21.

FIGS. 24a and 24b are graphical diagrams describing linear and curved adjustments, respectively, to a current-time product in phase 2 with respect to a difference in lamp voltage according to the method of FIG. 21.

FIG. 25 is a flowchart describing another embodiment of a method of operation for the ballast of FIG. 1.

FIG. 26 is a graphical diagram showing a lamp voltage during startup according to the method of FIG. 25.

FIGS. 27a and 27b are graphical diagrams describing linear and curved increases, respectively, in a current-time product in phase 2 with respect to a lamp voltage according to the method of FIG. 25.

FIG. 28 is a flowchart describing another embodiment of a method of operation for the ballast of FIG. 1.

FIG. 29 is a circuit diagram showing another embodiment of a lamp ballast of the present invention.

FIG. 30 is a graphical diagram showing lamp voltage adjustments relative to the cumulative lighting time in the lamp ballast of FIG. 29.

FIG. 31 is a flowchart describing an embodiment of a method of operation for the ballast of FIG. 30.

FIG. 32 is a graphical diagram showing adjustments in cumulative lighting time relative to the lamp voltage in another embodiment of a lamp ballast of the present invention.

FIGS. 33a and 33b are graphical diagrams showing adjustments in a lamp voltage and a current-time product, respectively, relative to the cumulative lighting time in the lamp ballast of FIG. 32.

FIGS. 34a, 34b and 34c are perspective views showing various examples of an illumination fixture utilizing an embodiment of a ballast according to the present invention.

FIG. 35a is a waveform showing a lamp current where a sufficiently long phase 2 duration is provided in a lamp ballast as previously known in the art.

FIG. 35b is a waveform showing a lamp current where a short phase 2 duration is provided in a lamp ballast as previously known in the art.

### DETAILED DESCRIPTION OF THE INVENTION

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in one embodiment,” as used herein does not necessarily refer to the same embodiment, although it may.

The term “coupled” means at least either a direct electrical connection between the connected items or an indirect connection through one or more passive or active intermediary devices.

The term “circuit” means at least either a single component or a multiplicity of components, either active and/or passive, that are coupled together to provide a desired function.

The term “signal” means at least one current, voltage, charge, temperature, data or other signal.

The terms “switching element” and “switch” may be used interchangeably and may refer herein to at least: a variety of transistors as known in the art (including but not limited to FET, BJT, IGBT, IGFET, etc.), a switching diode, a silicon controlled rectifier (SCR), a diode for alternating current (DIAC), a triode for alternating current (TRIAC), a mechanical single pole/double pole switch (SPDT), or electrical, solid state or reed relays. Where either a field effect transistor (FET) or a bipolar junction transistor (BJT) may be employed as an embodiment of a transistor, the scope of the terms “gate,” “drain,” and “source” includes “base,” “collector,” and “emitter,” respectively, and vice-versa.

The terms “power converter” and “converter” as used herein generally refer to an inverter circuit for DC-AC power conversion, but is not so inherently limited, and with respect to any particular element may be used interchangeably herein and with reference to at least DC-DC, DC-AC, AC-DC, buck, buck-boost, boost, half-bridge, full-bridge, H-bridge or various other forms of power conversion or inversion as known to one of skill in the art.

The term “half-wave discharge” and “rectification” unless otherwise stated herein may generally refer to a status resulting from asymmetric operation with respect to positive and negative peaks of a waveform for a defined signal.

The term “lighting time” for a lamp as used herein may generally refer to an amount of time between the ignition and extinguishing of the lamp, wherein an irradiated light output from the lamp may be detected. The term “cumulative lighting time” for a lamp as used herein may therefore generally refer to the total amount of lighting time detected for the lamp since installation of the lamp.

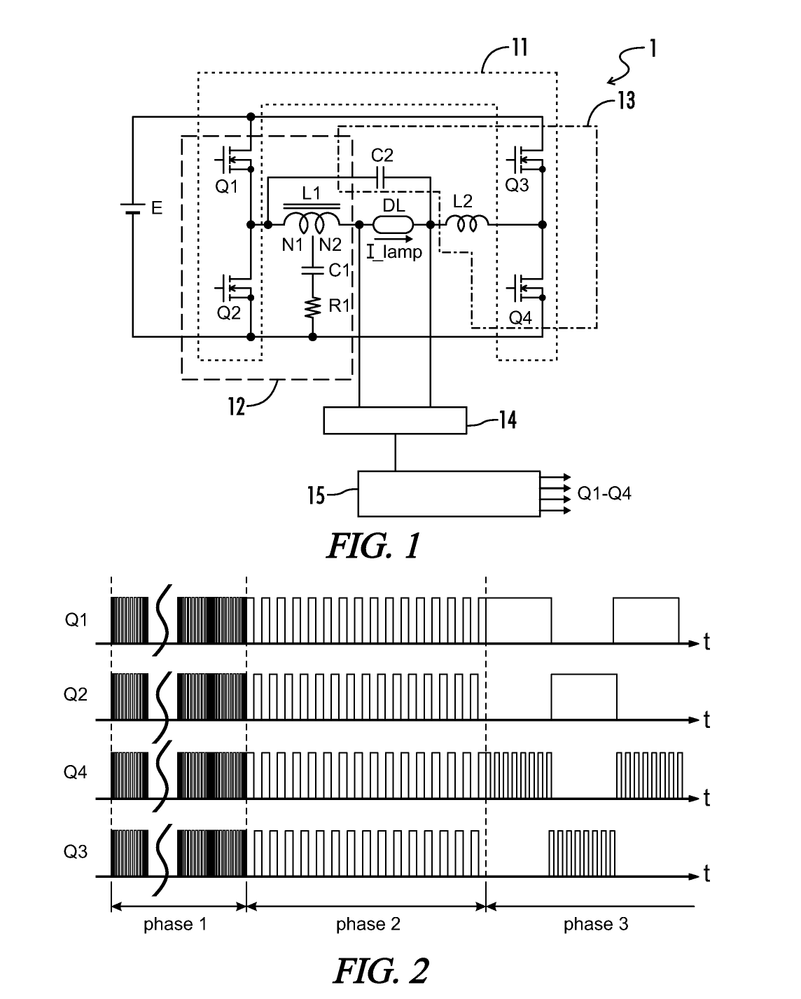

Referring generally to FIGS. 1-34, description will be made herein of various embodiments of a high pressure discharge lamp ballast and various embodiments of methods of using the same, and illumination fixtures and illumination systems incorporating the ballasts and methods of the present invention. The various embodiments of high pressure discharge lamp ballasts so described are generally provided for powering high pressure discharge lamps such as HID lamps.

Referring to FIG. 1, an embodiment of a high pressure discharge lamp ballast is shown for powering a lamp DL which may be a high pressure discharge lamp such as an HID lamp. A power converter may be included to convert a DC power input from a DC power supply E into AC power, such as an inverter circuit in this example having a full bridge circuit 11 with four switching elements Q1 to Q4. In the embodiment shown, field effect transistors (FETs or MOSFETs) are used for the switching elements Q1 to Q4.

A first pair of switching elements Q1, Q2 and a second pair of switching elements Q3, Q4 are each connected in parallel with the DC power supply E, with a node between the switching elements Q1 and Q2 (which may also be referred to as an output terminal of the power converter) coupled to a filament on a first end of the lamp DL via a first inductor L1, and a node between the switching elements Q3 and Q4 coupled to the filament on a second end of the lamp DL via a second inductor L2.

The first inductor L1 in the embodiment shown has an autotransformer structure with a tap, and the tap is connected to a negative terminal of the DC power supply E (e.g., to ground) via a series RC circuit including a first capacitor C1 and a resistor R1. The first inductor L1 and the RC circuit constitute, along with the switching elements Q1 and Q2, a starting circuit 12 for generating a high voltage to cause a dielectric breakdown of the lamp DL. While the starting circuit 12 as shown is of a typical configuration as known to one of skill in the art for generating a high voltage using resonance characteristics, an equivalent system capable of generating a high voltage in a pulse manner is also anticipated such as for example a system using a piezoelectric element.

A node between the first inductor L1 and the switching elements Q1 and Q2 is coupled to a second capacitor C2 that constitutes, along with the switching elements Q3 and Q4 and the second inductor L2, a step-down chopper circuit 13 (or buck chopper 13).

The high pressure discharge lamp ballast 1 according to the embodiment shown may further include a lamp status detection circuit 14 for detecting a status of the lamp DL and storing a detection result, and a control circuit 15 for controlling the turning on and off of the switching elements Q1 to Q4.

The lamp status detection circuit 14 may in various embodiments include a non-volatile memory, not shown, and counts the lighting time of the lamp DL and stores a cumulative lighting time obtained by integrating the counted periods of time.

The control circuit 15 may be, for example, a microprocessor configured to drive the switching elements Q1 to Q4 on and off in such a manner that mutually diagonal switching elements of the switching elements Q1 to Q4 are simultaneously turned on while switching elements connected in series are alternately turned on or off. This causes DC power input from the DC power supply E to be converted into AC power that has a frequency of inversed polarity obtained by the on/off driving of the switching elements Q1 to Q4 (this frequency being hereinafter referred to as an “operating frequency” with respect to the power converter).

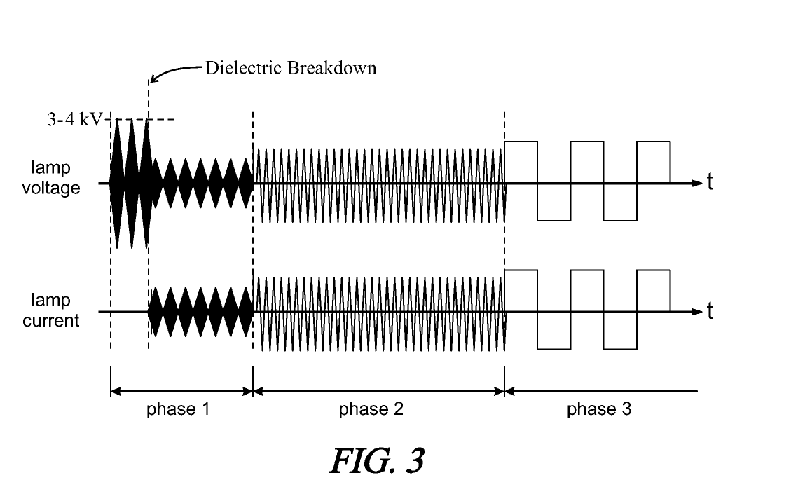

The operation of the high pressure discharge lamp ballast 1 as shown in FIG. 1 may be described with reference to FIGS. 2 and 3. FIG. 2 shows driving signals applied to the gates of the switching elements Q1 to Q4, and FIG. 3 shows waveforms of a lamp voltage and a lamp current actually applied to the lamp DL.

In FIG. 2, each of the switching elements Q1 to Q4 is on during a period of time when the driving signal is an H level and off during a period of time when the driving signal is an L level. Note that the periods of the H and L levels are set to be equal.

When the power supply is turned on, the control circuit 15 initiates a starting sequence for the lamp DL to reach a stable lighting state. Simultaneously, the lamp status detection circuit 14 starts to count time.

The starting sequence is divided into a period during which a high voltage of a high frequency required for dielectric breakdown is applied to the lamp DL (hereinafter referred to as “phase 1”), a period during which the filaments are sufficiently heated after the dielectric breakdown of the lamp DL (hereinafter referred to as “phase 2”), and a period of normal operation during which the lamp DL maintains a stable light output by causing a low-frequency rectangular wave current to flow through the lamp DL (hereinafter referred to as “phase 3”). Operation in each of the phases will be described in detail below.

In phase 1, the control circuit 15 changes the operating frequency periodically (or “sweeps” the operating frequency) within the range of several tens kHz to several hundreds kHz and applies the operating frequency to the switching elements Q1 to Q4. The operating frequency approaches a resonant frequency (or an integer fraction thereof) of a resonant circuit composed of a primary winding N1 side of the first inductor L1 and the first capacitor C1. A resonance voltage occurring at this time is boosted at the first inductor L1 having an autotransformer structure with a winding ratio of N1:N2, whereby a voltage applied to the lamp DL (hereinafter referred to as a “lamp voltage”) reaches a voltage required to start discharge, e.g. 3 to 4 kV, and thus the lamp DL is ignited.

FIG. 3 shows dielectric breakdown occurring in a third cycle of periodical change of the operating frequency which ignites the lamp DL and allows the lamp current to flow, and that the amplitude of the lamp voltage is diminished by a change of impedance due to igniting of the lamp DL.

After a predetermined period of time phase 1 ends, followed by transition to phase 2, during which the filaments of the lamp DL are heated at a lower operating frequency than that of phase 1, e.g. several tens kHz.

The operating frequency in phase 2 may be set to a frequency closer to a resonant frequency of a load circuit coupled to the full bridge circuit 11, compared with an operating frequency in phase 3 as described later. Note that the operating frequency and the lamp current each may be an extremely low frequency.

Phase 2 continues for a predetermined period of time determined in accordance with the cumulative lighting time of the lamp DL as will be described later, and subsequently the operation in phase 3 starts.

In phase 3, the control circuit 15 further reduces the operating frequency, e.g. several hundreds Hz, with respect to the operating frequency in phase 2, and thus supplies the lamp DL with rectangular wave AC power to maintain a stable light output from the lamp DL. In phase 3, the control circuit 15 carries out PWM control whereby power supplied to the lamp DL is adjusted by turning on/off the switching elements Q3 and Q4 of one series circuit at a predetermined duty ratio, instead of turning them on constantly over the period during which the switching elements Q1 and Q2, which are respectively diagonal to the switching elements Q3 and Q4, are turned on.

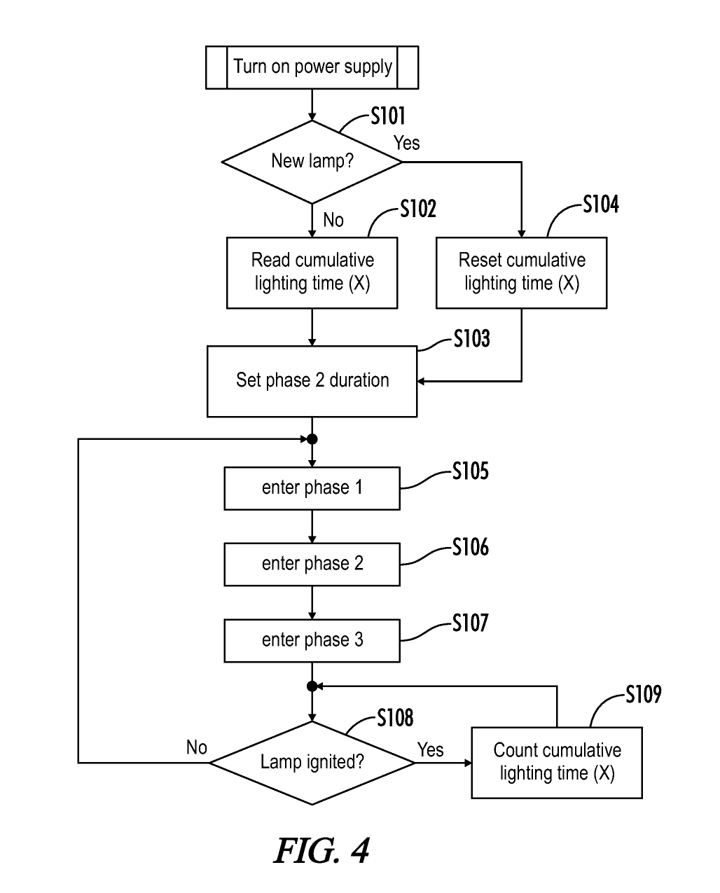

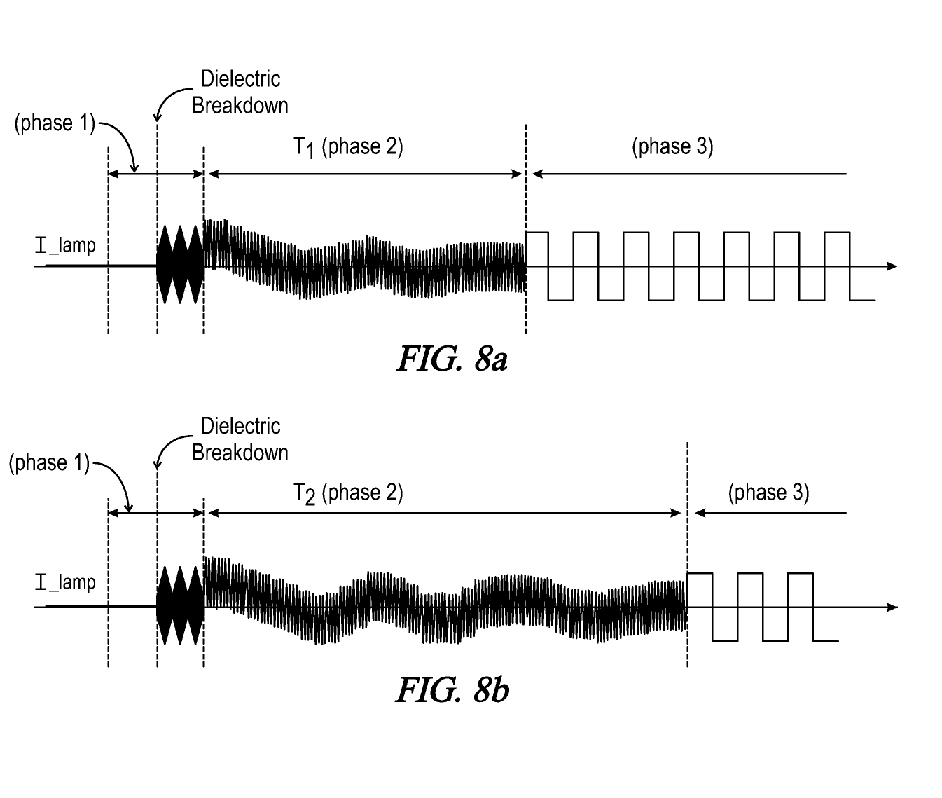

With reference to FIGS. 4-8 an embodiment of a method of operation of the lamp status detection circuit 14 may now be described.

Where phase 2 of the startup sequence of the high pressure discharge lamp ballast immediately follows dielectric breakdown of the lamp DL, the filaments are not heated sufficiently. This may generally cause a half-wave discharge condition (e.g., rectification) as shown in FIG. 8, where the lamp current is asymmetrical with respect to the positive/negative polarities. If this half-wave discharge continues, flickering or even extinguishing of the light may occur after transition to phase 3, or in other words an unstable light output. This is in many cases observed in high pressure discharge lamps at the end of their service life, or in other words having a long cumulative lighting time.

The lamp status detection circuit 14, which is provided to solve this problem, detects a lighting time as an indicator of the status of the lamp DL and stores a cumulative lighting time X obtained by integrating previously detected lighting times stored in a non-volatile memory (not shown). Note that the storage function for the cumulative lighting time X can be performed by a memory which is usually provided in a microprocessor of the control circuit 15. It is also possible to provide an external storage device attached to the high pressure discharge lamp ballast 1 so as to store the cumulative lighting time X.

The lamp status detection circuit 14 may also reset the cumulative lighting time X to an initial value when the high pressure discharge lamp DL is replaced with a new lamp. FIG. 4 is a flowchart describing a procedure of the starting sequence where the lamp status detection circuit 14 resets the cumulative lighting time X to an initial value.

After the power supply is turned on, it may be determined in step S101 whether the high pressure discharge lamp DL is new. If the result shows that the high pressure discharge lamp DL has not been replaced with a new lamp, the cumulative lighting time X previously stored in the lamp status detection circuit 14 is read (step S102).

Next, the control circuit 15 sets the duration of phase 2 in accordance with the cumulative lighting time X that was read (step S103).

If it is determined in the procedure of step S101 that the high pressure discharge lamp DL is replaced with a new lamp, the cumulative lighting time X stored in the lamp status detection circuit 14 is reset in step S104, and the method proceeds to step S103.

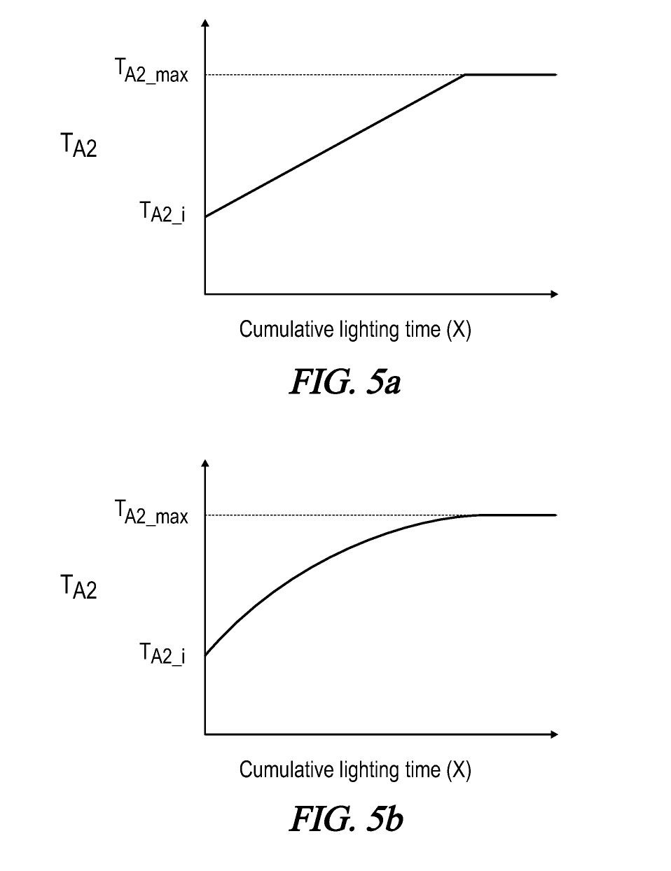

The duration of phase 2 is set or adjusted in accordance with the cumulative lighting time of the lamp, with the duration of phase 2 by necessity being longer for lamps having a longer cumulative lighting time and being shorter for lamps that have a shorter cumulative lighting time. Referring to FIG. 5a, the increase in the duration TA2 of phase 2 may be linear with respect to an increase in the cumulative lighting time X, wherein with reference to FIG. 5b the increase in the duration TA2 of phase 2 may be curved or exponential with respect to an increase in the cumulative lighting time X.

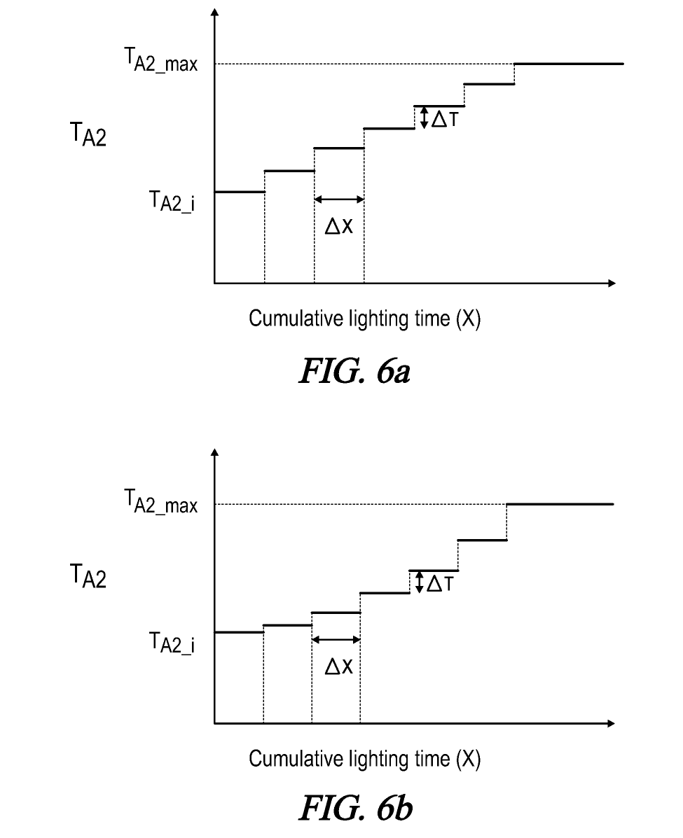

FIGS. 6a and 6b demonstrate stepped increases in the duration TA2 of phase 2 with respect to stepped increases in the cumulative lighting time X. FIG. 6a shows a case in which a divided period ΔX of the cumulative lighting time X is constant and FIG. 6b shows a case in which the divided period ΔX increases in accordance with increases in the cumulative lighting time X.

In FIGS. 5a and 5b and 6a and 6b, for a new or unused high pressure discharge lamp with zero cumulative lighting time, a duration for phase 2 is set to an initial value TA2_i as needed to heat the filaments, while a predetermined maximum value TA2_MAX is set for the duration of phase 2 in order to prevent an extreme reduction of the lamp life resulting from excessive heating.

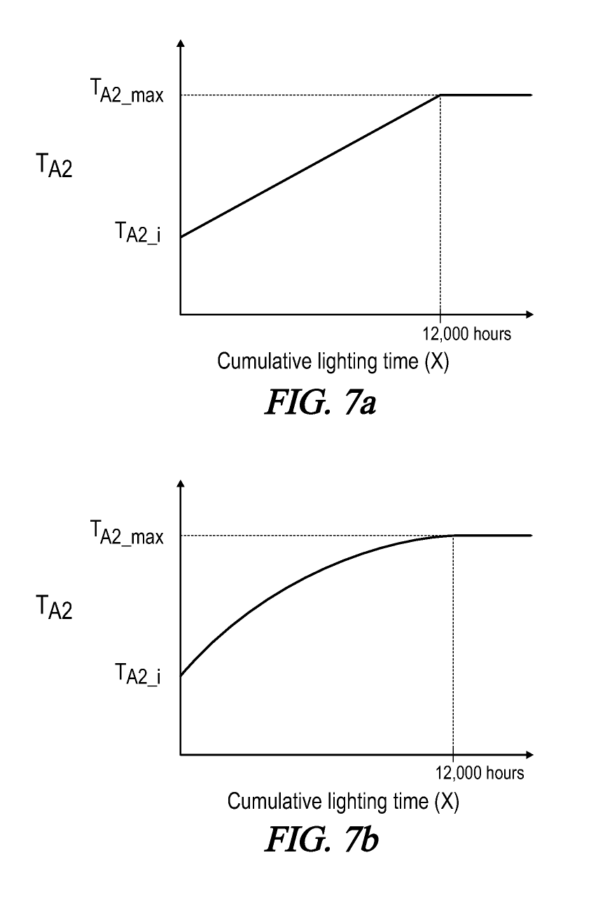

Referring now to FIGS. 7a and 7b, the duration TA2 of phase 2 may also be set to reach the predetermined maximum value TA2_MAX when the cumulative lighting time X reaches and/or extends beyond a rated lifetime of the high pressure discharge lamp. For example, a Cerameta lamp 150 W (MT150CE) manufactured by Panasonic Corporation has a rated lifetime of 12000 hours, and upon counting a cumulative lighting time of or beyond 12000 hours, the current-time product TA2 in phase 2 reaches the predetermined maximum value TA2_MAX.

Setting the duration TA2 of phase 2 in the above manner may eliminate excessive electrical stresses that would otherwise be applied to a new high pressure discharge lamp, and may enable sufficient filament heating for a high pressure discharge lamp having a long cumulative lighting time and which easily suffers unstable discharge, thereby realizing stable discharge at the time of transition to phase 3 regardless of the cumulative lighting time of the high pressure discharge lamp.

FIGS. 8a and 8b show lamp current waveforms for a new or unused high pressure discharge lamp and a high pressure discharge lamp at the end of its service life, respectively, with phase 2 durations established in accordance with the cumulative lamp lighting time X using a method of the present invention as previously described.

FIGS. 8a and 8b show that in accordance with cumulative lighting times X1 and X2 (X1<X2) respectively of the unused high pressure discharge lamp and the high pressure discharge lamp at the end of its service life, durations T1 and T2 (i.e. T1<T2) of phase 2 are set, and thus both high pressure discharge lamps form stable discharge in phase 3.

Referring back to the flowchart in FIG. 4, the above-described phases 1 to 3 of the startup sequence are executed in steps S105 to S107. In following step S108, an operation is executed to determine if the lamp DL has been ignited, and if it is determined that ignition has not taken place, the method returns to step S105 and repeats.

In contrast, if it is determined in step S108 that the lamp DL has been ignited, then in step S109 the lamp status detection circuit 14 counts and stores the cumulative lighting time X. Then the process returns to step S108 and repeats the operation to determine whether the lamp DL is still ignited and operating.

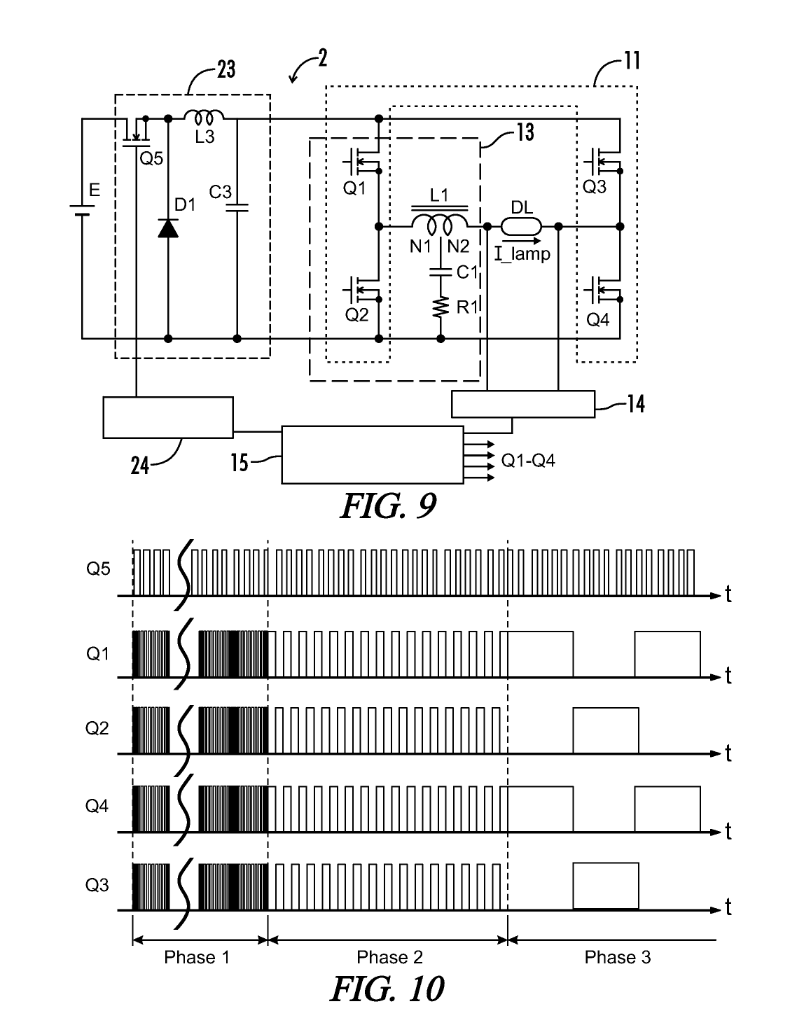

Referring now to FIG. 9, in an embodiment the step-down chopper circuit 13 from the ballast of FIG. 1 may be replaced with another step-down chopper circuit 23 coupled across the power supply E. Note that in an embodiment such as shown in FIG. 9, for components that are similar to those of an embodiment as shown in FIG. 1, like reference numbers are used and description thereof will be simplified or omitted.

The step-down chopper circuit 23 may have a switching element Q5 connected at one end to a high voltage side of the DC power supply E and at the other end to an input terminal of the full bridge circuit 11 via an inductor L3, a diode D1 having a cathode connected to a node between the switching element Q5 and the inductor L3 and an anode connected to the ground, and a capacitor C3 coupled in parallel with input terminals of the full bridge circuit 11. Note that the second inductor L2 and the second capacitor C2 of the step-down chopper circuit 13 show in FIG. 1 are omitted. A step-down chopper driving circuit 24 controlled by the control circuit 15 may be coupled to the gate of the switching element Q5.

A current output from the DC power supply E is controlled by the step-down chopper circuit 23 and supplied to the full bridge circuit 11. This control may be carried out by the step-down chopper driving circuit 24, which drives the switching element Q5 with an on/off duty ratio as shown in FIG. 10, and thus no PWM control is carried out by turning on/off the switching elements Q1 to Q4 in the full bridge circuit 11 even in phase 3.

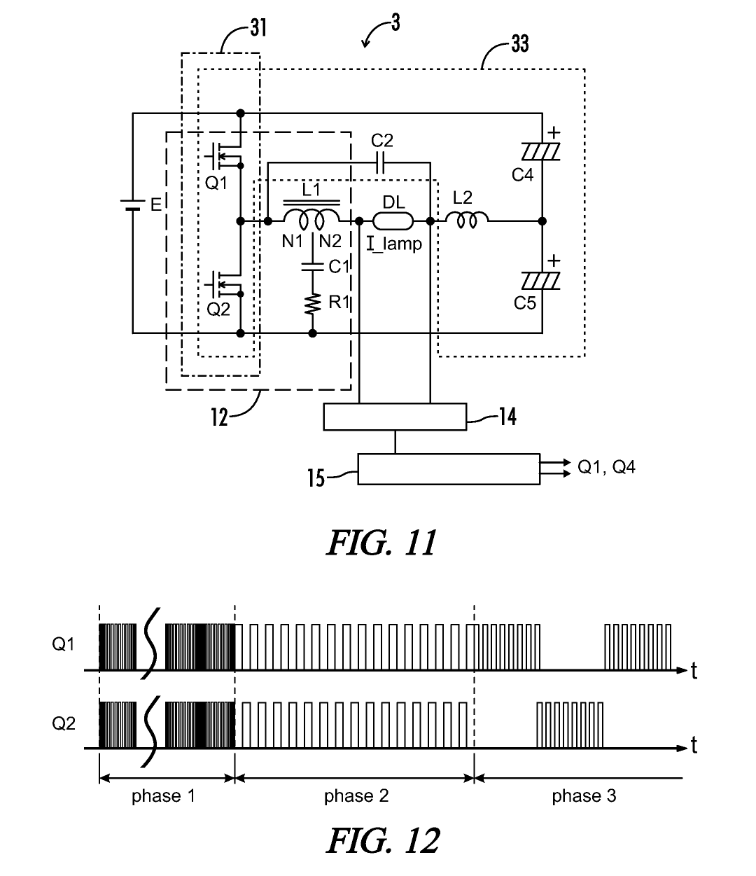

Referring to FIG. 11, in an embodiment the high pressure discharge lamp ballast 3 includes a half-bridge circuit 31 having two switching elements Q1 and Q2 connected in series and a step-down chopper circuit 33 in which the switching elements Q3 and Q4 of the embodiment shown in FIG. 1 are respectively replaced with capacitors C4 and C5.

As shown in FIG. 12, the on/off driving of the switching elements Q1 and Q2 in the half-bridge circuit 31 in phase 1 and phase 2 is the same as previously described with respect to an embodiment such as shown in FIG. 2, whereas in phase 3, PWM control is carried out to adjust power output to the lamp DL using the on/off duty ratio of the switching elements Q1 and Q2, which should be turned on in a period of no polarity inversion.

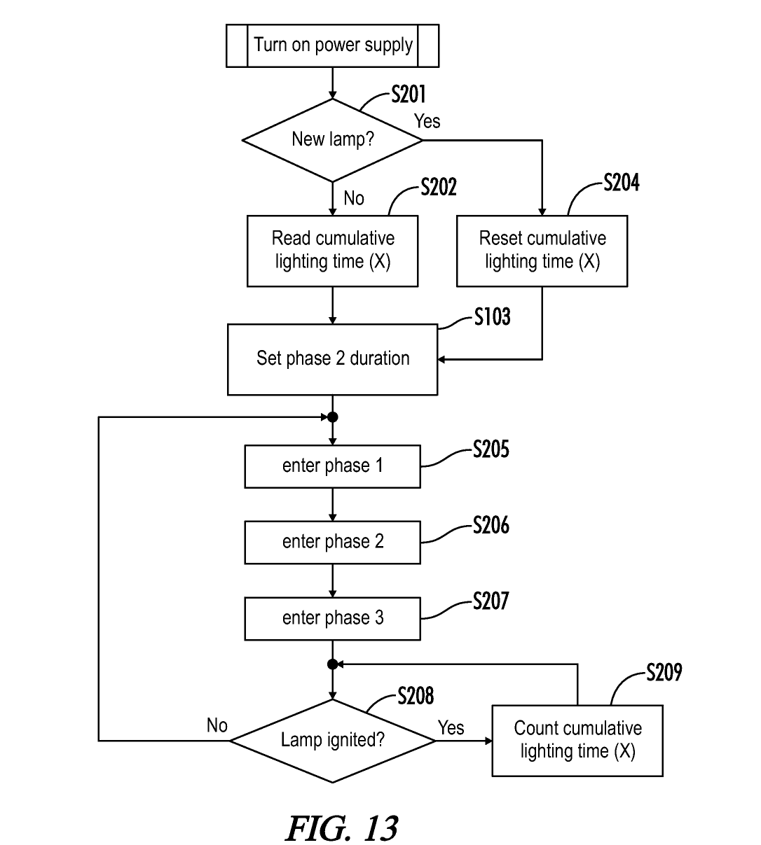

Referring to FIG. 13, in an embodiment the control circuit 15 sets the value of a current supplied to the lamp DL in phase 2 in accordance with the cumulative lighting time X of the lamp stored in the lamp status detection circuit 14. Note that various procedures in steps S201, S202 and S204 to S209 in the flowchart shown in FIG. 13 are respectively the same as those in steps S101, S102 and S104 to S109 in the embodiment as shown in FIG. 4, and therefore further description of these steps will be omitted.

In step S203, the control circuit 15 reads the cumulative lighting time X from the lamp status detection circuit 14, and sets a lamp current value in phase 2 in accordance with the cumulative lighting time X that was read.

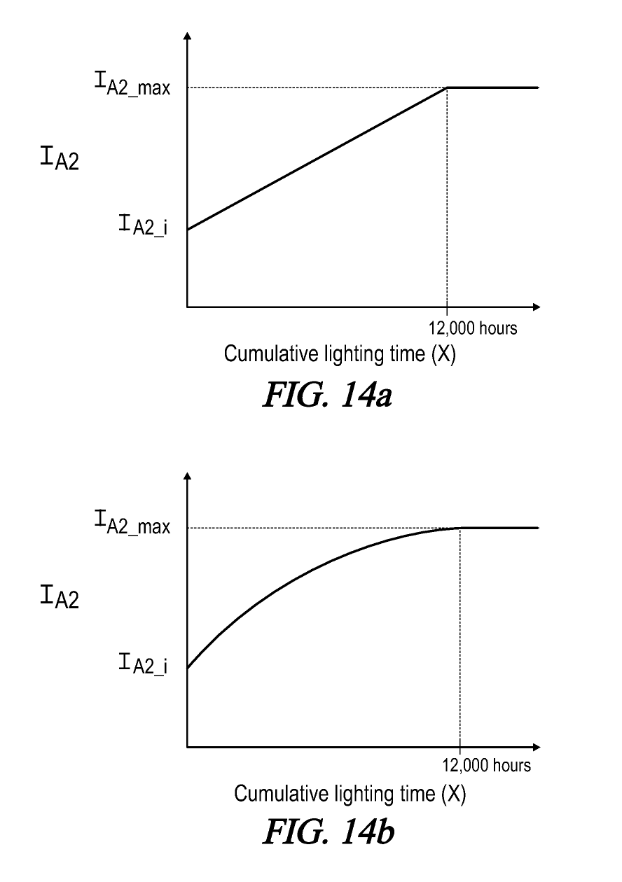

The lamp current value in phase 2 may be set or adjusted in accordance with the cumulative lighting time of the lamp, with the lamp current in phase 2 by necessity being larger for lamps having a longer cumulative lighting time and being smaller for lamps that have a shorter cumulative lighting time. Referring to FIG. 14a, the increase in the lamp current IA2 in phase 2 may be linear with respect to an increase in the cumulative lighting time X, wherein with reference to FIG. 14b, the increase in the lamp current IA2 in phase 2 may be curved with respect to an increase in the cumulative lighting time X.

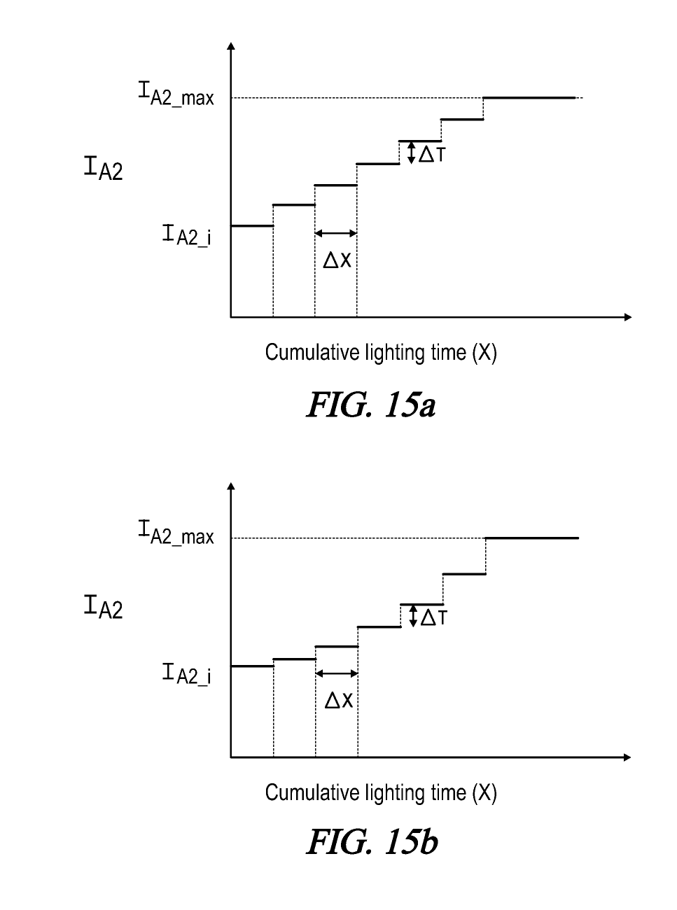

FIGS. 15a and 15b demonstrate stepped increases in the lamp current IA2 in phase 2 with respect to stepped increases in the cumulative lighting time X. FIG. 15a shows an example where a divided period ΔX of the cumulative lighting time X is constant and FIG. 15b shows an example in which the divided period ΔX increases in accordance with increases in the cumulative lighting time X.

In various embodiments, for a new or unused high pressure discharge lamp with zero cumulative lighting time, a lamp current in phase 2 may be set to an initial value IA2_i as needed to heat the filaments, while a predetermined maximum value IA2_MAX is set for the lamp current in phase 2 in order to prevent an extreme reduction of the lamp life resulting from excessive heating.

While the initial value IA2 thus established for the lamp current value is subjected to constant current control by the control circuit 15, other methods include setting the lamp current in accordance with a lamp voltage by using the cumulative lighting time as a parameter.

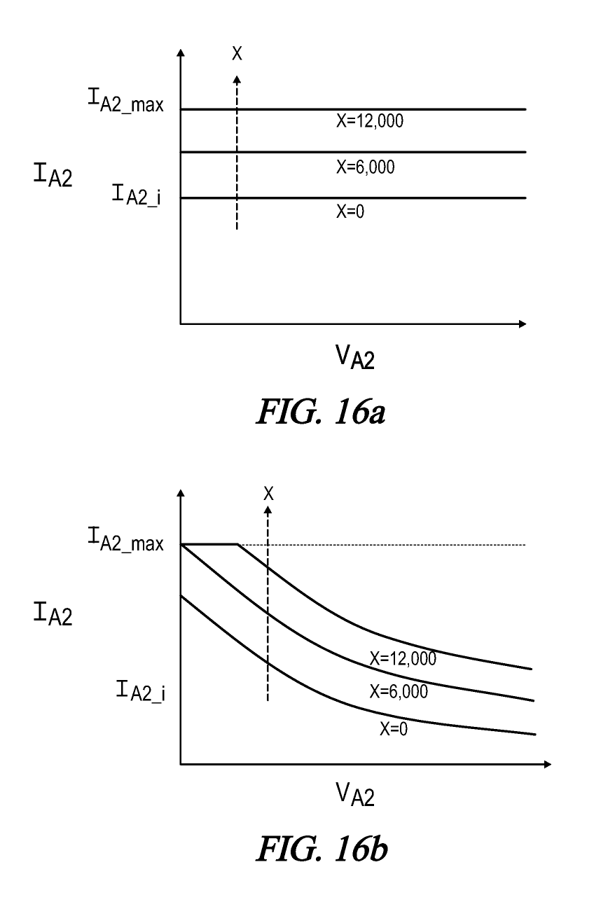

Referring now to FIGS. 16a and 16b, the lamp current value IA2 set in phase 2 may be controlled in accordance with the lamp voltage VA2 by using the cumulative lighting time X as a parameter, wherein FIG. 16a shows constant control and FIG. 16b shows control by a VI curve.

Setting the lamp current IA2 of phase 2 in the above manner may eliminate excessive stress that would otherwise be applied to a new high pressure discharge lamp, and may enable sufficient filament heating for a high pressure discharge lamp having a long cumulative lighting time and which easily suffers unstable discharge, thereby realizing stable discharge at the time of transition to phase 3 regardless of the cumulative lighting time of the high pressure discharge lamp.

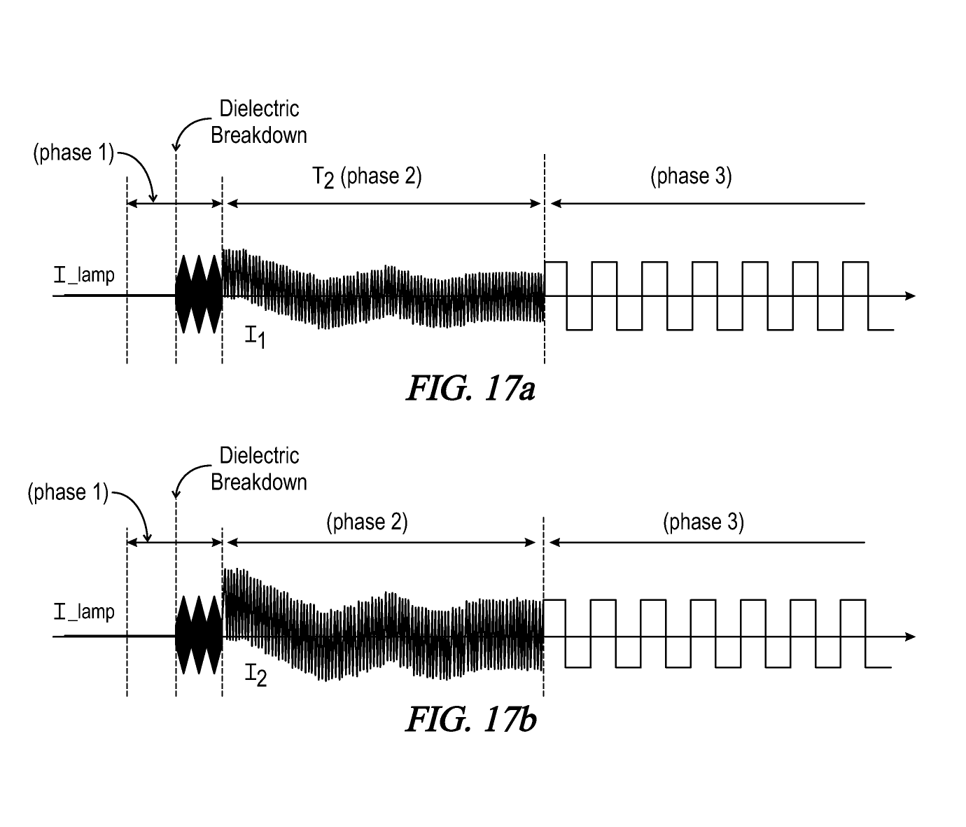

FIGS. 17a and 17b show lamp current waveforms for a new or unused high pressure discharge lamp and a high pressure discharge lamp at the end of its service life, respectively, with phase 2 lamp currents established in accordance with the cumulative lamp lighting time X using a method of the present invention as previously described.

FIGS. 17a and 17b show that in accordance with cumulative lighting times X1 and X2 (X1<X2) respectively of the unused high pressure discharge lamp and the high pressure discharge lamp at the end of its service life, lamp current values I1 and I2 (i.e. I1<I2) of phase 2 are set, and thus both the unused high pressure discharge lamp and the high pressure discharge lamp at the end of its service life form stable discharge in phase 3.

In various embodiments as described above, a high pressure discharge lamp ballast may include the lamp status detection circuit 14 for counting and storing the cumulative lighting time of the lamp DL so that under the control of the control circuit 15, the lamp current value in phase 2 of the startup sequence is set in accordance with the cumulative lighting time X, which eliminates excessive stress to a new high pressure discharge lamp and enables sufficient filament heating for a high pressure discharge lamp having a long cumulative lighting time, which easily suffers unstable discharge. Thus, both high pressure discharge lamps form stable discharge at the time of transition to the third period.

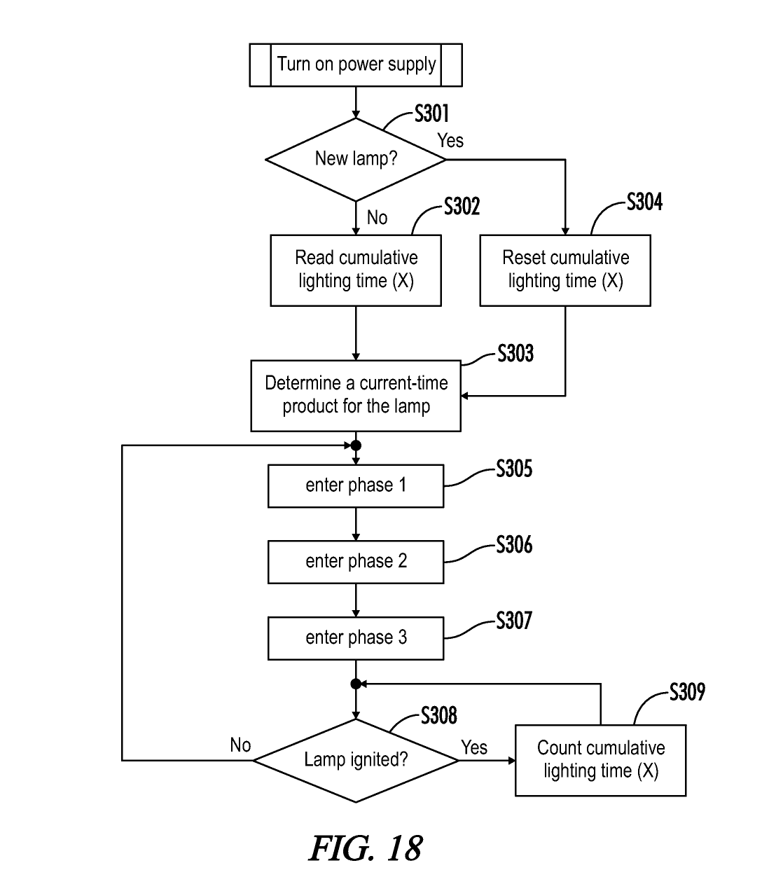

Referring now to FIG. 18, in another embodiment a control circuit 15 in the high pressure discharge lamp ballast determines a current-time product by combining control of a phase 2 duration TA2 and control of a lamp current value IA2 in phase 2, and controls the amount of power supplied to the lamp DL in phase 2 based on the lamp cumulative lighting time X and the determined current-time product. Note that various procedures in steps S301, S302 and S304 to 5309 as shown in FIG. 18 are respectively substantially the same as those in steps S101, S102 and 5104 to S109 shown in FIG. 4, and description thereof will be omitted.

In step S303, the control circuit 15 determines a current-time product of the lamp in phase 2 in accordance with the cumulative lighting time X read from a memory of the lamp status detection circuit 14.

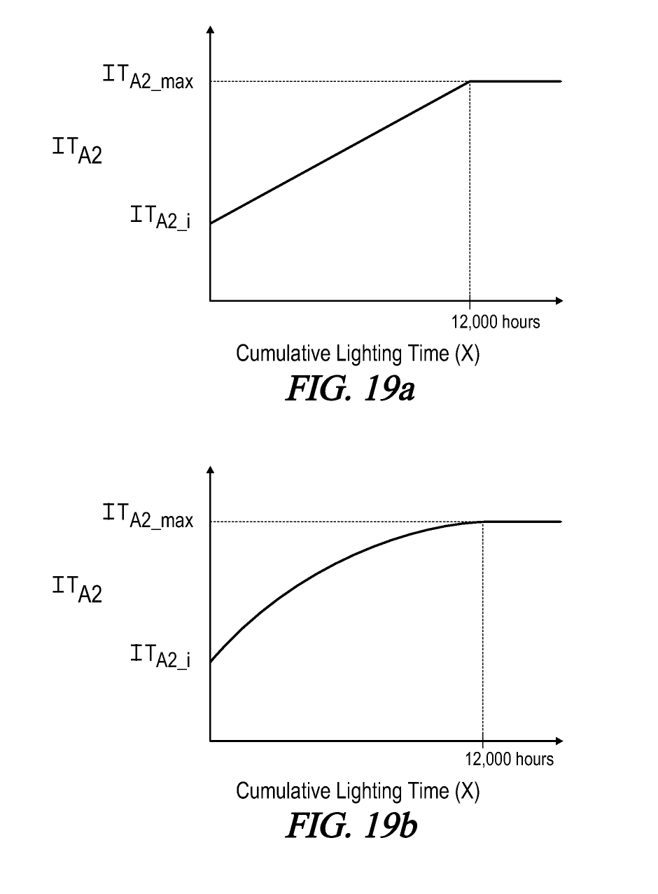

The current-time product determined in phase 2 may be adjusted in accordance with the lamp cumulative lighting time X. FIGS. 19a and 19b show examples of increasing a current-time product ITA2 established in phase 2 in accordance with the cumulative lighting times X, wherein FIG. 19a shows a linear increase and FIG. 19b shows a curved increase.

The current-time product in phase 2 may be set or adjusted in accordance with the cumulative lighting time of the lamp, with the current-time product in phase 2 by necessity being larger for lamps having a longer cumulative lighting time and being smaller for lamps that have a shorter cumulative lighting time. Referring to FIG. 19a, the increase in the current-time product ITA2 in phase 2 may be linear with respect to an increase in the cumulative lighting time X, whereas with reference to FIG. 19b the increase in the current-time product ITA2 in phase 2 may be curved with respect to an increase in the cumulative lighting time X.

For a new or unused high pressure discharge lamp with zero cumulative lighting time, a current-time product of a high pressure discharge lamp is established in phase 2 as an initial value ITA2_j to sufficiently heat the filaments, and a predetermined maximum value ITA2_MAX is set to prevent an extreme reduction of the lamp life resulting from excessive heating.

In various embodiments, the method may use a lamp status detection circuit 14 for counting and storing the cumulative lighting time of the lamp DL so that under the control of the control circuit 15, the current-time product of the lamp in phase 2 of the startup sequence is determined in accordance with the cumulative lighting time X, and the amount of current supplied to the high pressure discharge lamp is controlled in accordance with the determined current-time product, which eliminates excessive stress to a new high pressure discharge lamp and enable's sufficient filament heating for a high pressure discharge lamp of long cumulative lighting time, which easily suffers unstable discharge. Thus, both high pressure discharge lamps form stable discharge at the time of transition to the third period.

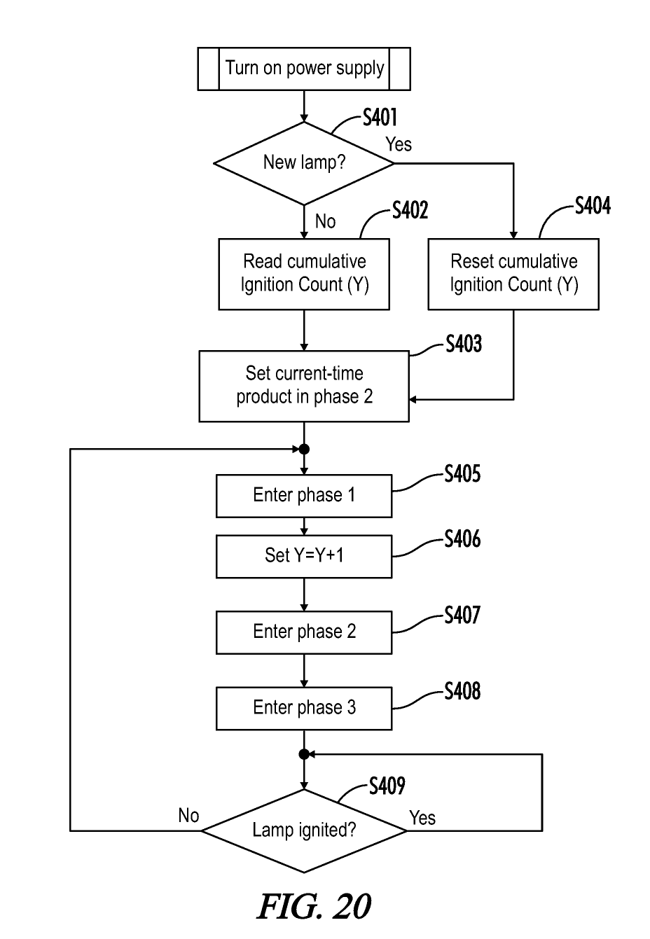

Referring to FIG. 20, in another embodiment a high pressure discharge lamp ballast includes a lamp status detection circuit 14 that detects and adds the number of times that the lamp DL has been ignited, and stores the result as a cumulative ignition count Y. The control circuit 15 determines a current-time product in phase 2 in accordance with the cumulative ignition count Y of the lamp DL, and controls the amount of power supplied to the lamp DL based on the determined current-time product.

After the power supply is turned on, it is determined in step S401 whether the high pressure discharge lamp DL has been replaced with a new lamp. If not, the cumulative ignition count Y is read from the lamp status detection circuit 14 in which it is stored (step S402).

Next, a current-time product of the lamp in phase 2 is determined in accordance with the cumulative ignition count Y (step S403).

In contrast, if it is determined in step S401 that the high pressure discharge lamp DL has been replaced with a new lamp, the cumulative ignition count Y stored in the lamp status detection circuit 14 is reset in step S404, and the method proceeds to step S403.

The current-time product established in phase 2 is as previously described, and therefore further description will be omitted.

In step S405, phase 1 of the starting sequence described above is executed under the control of the control circuit 15. Then in step S406, the cumulative ignition count Y of the lamp DL in increased by one (Y=Y+1) and the increased cumulative ignition count Y is stored.

In step S407, under the control of the control circuit 15, phase 2 of the starting sequence described above is executed based on the established current-time product, and phase 3 is executed in the following step S408.

In step S409, an operation is conducted to determine if the lamp DL has been ignited (step S409), and if it is determined that no ignition has occurred, or that the light has been extinguished, the method returns to step S405 and repeats from that point.

In an embodiment, therefore, the high pressure discharge lamp ballast includes the lamp status detection circuit 14 for counting and storing the cumulative ignition count of the lamp DL, so that under the control of the control circuit 15 the current-time product of the lamp in phase 2 of the startup sequence is determined in accordance with the cumulative ignition count Y, and the amount of current supplied to the high pressure discharge lamp DL in phase 2 is controlled in accordance with the determined current-time product ITA2, which eliminates excessive stress to a new high pressure discharge lamp and enables sufficient filament heating for a high pressure discharge lamp of long cumulative lighting time, which easily suffers unstable discharge. Thus, both high pressure discharge lamps form stable discharge at the time of transition to the third period.

Note that it is also possible to set the amount of power supplied to the lamp DL in phase 2 based on the above-described cumulative ignition count Y of the lamp DL and also the cumulative lighting time X of the lamp DL.

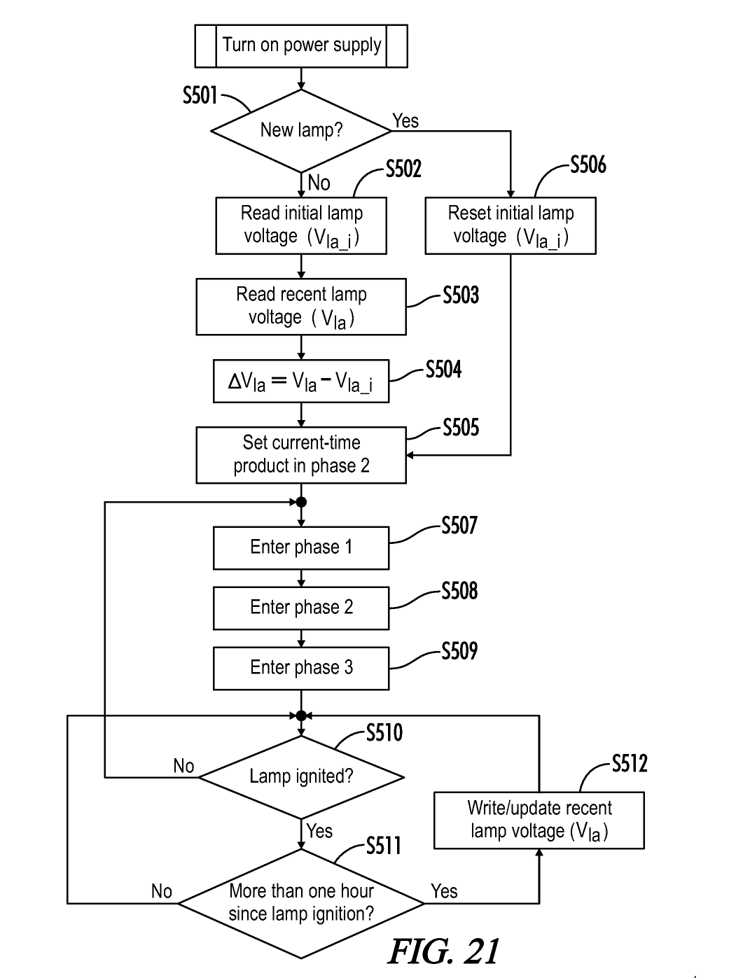

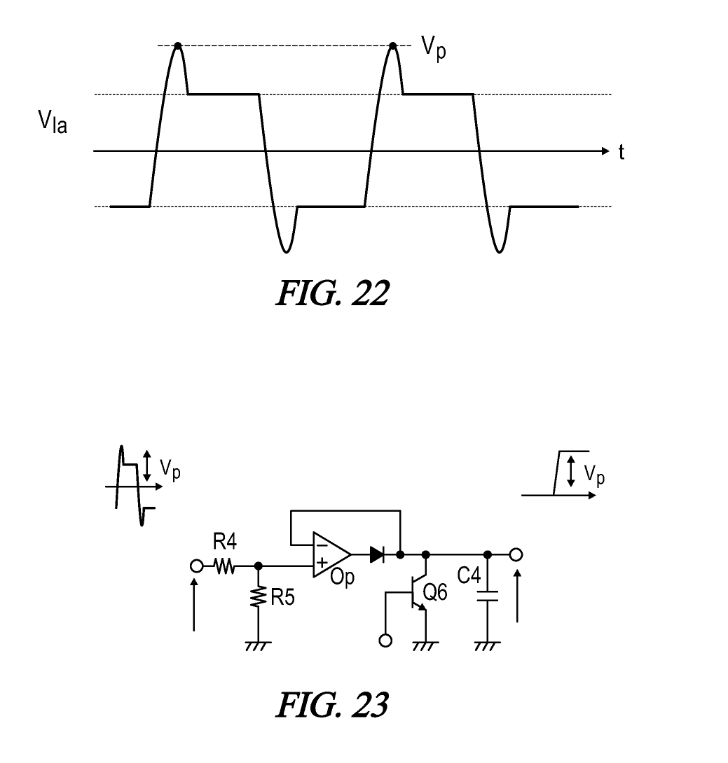

Referring now to FIG. 21, a high pressure discharge lamp ballast includes a lamp status detection circuit 14 which divides the voltage across the lamp DL during normal operation by a resistor or equivalent means and detects an effective value of the lamp voltage in phase 3. Then the lamp status detection circuit 14 stores a lamp voltage value from a first ignition after installation of the lamp DL, and also stores a lamp voltage value from the most recent lamp ignition. Note that a re-ignition voltage Vp at the peak of one cycle of lamp voltage may also be used in place of the effective value of the lamp voltage in phase 3 (see FIG. 22).

Referring to FIG. 23, an example is shown of a circuit to detect the re-ignition voltage Vp of the lamp voltage, wherein the voltage across the lamp is divided by resistors R4 and R5, followed by detecting the peak value Vp of the lamp voltage by using a comparator Op.

The control circuit 15 reads the lamp voltage effective values at recent and initial ignition from the lamp status detection circuit 14 so as to obtain a difference between the two values, followed by determining a current-time product in phase 2 in accordance with the difference of the effective values and controlling the amount of power supplied to the lamp DL based on the established current-time product.

In general, a lamp with a long cumulative lighting time (i.e., a relatively old lamp) tends to have a high discharge maintaining voltage and also a high lamp voltage during a period of stable light output. This tendency may be utilized in controlling the amount of power supplied to the lamp DL, in order to improve the stability of the lamp DL during discharge.

Referring back to the method of FIG. 21, after the power supply is turned on, it is determined in step S501 whether the high pressure discharge lamp DL has been replaced with a new lamp. If the result shows that the high pressure discharge lamp DL has not been replaced with a new lamp, a lamp voltage effective value Vla_i from the first ignition is read from the lamp status detection circuit 14 where it has been stored previously (step S502).

Next, a recent lamp voltage effective value Vla is read from the lamp status detection circuit 14 (step S503), and a difference ΔVla relative to the lamp voltage effective value Vla_i of first ignition is obtained (step S504).

Then, a current-time product of the lamp in phase 2 is determined in accordance with the difference ΔVla in lamp voltage effective value (step S505).

In contrast, if it is determined in the procedure in step S501 that the high pressure discharge lamp DL has been replaced with a new lamp, the lamp voltage effective value Vla_i of first ignition which has previously been stored in the lamp status detection circuit 14 is reset in step S506, and the method skips to step S505.

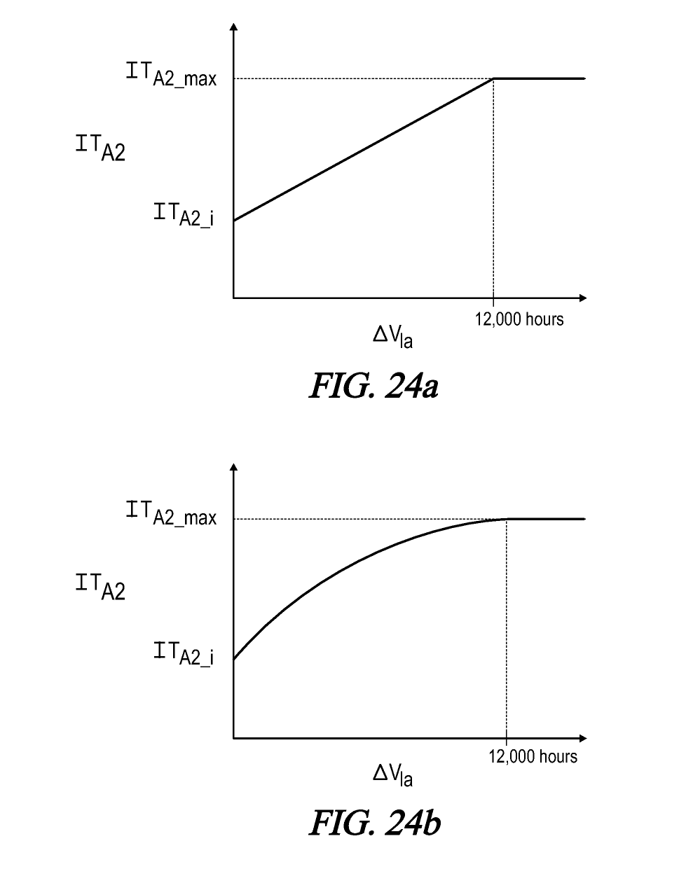

The current-time product determined in phase 2 may be adjusted in accordance with the difference ΔVla in lamp voltage effective value. FIG. 24 shows examples of increasing the current-time product ITA2 determined in phase 2 in accordance with the difference ΔVla in lamp voltage effective value, wherein FIG. 24a shows a linear increase and FIG. 24b shows a curved increase.

In FIG. 24, for a new or unused high pressure discharge lamp with zero cumulative lighting time, a current-time product is established in phase 2 as an initial value ITA2_j to sufficiently heat the filaments, and a predetermined maximum value ITA2_MAX is set to prevent an extreme reduction of the life of the high pressure discharge lamp resulting from excessive heating.

Referring back to the flowchart in FIG. 21, the procedures in steps S507 to S510 are respectively the equivalent to those in steps S105 to S108 according to various previously described embodiments and therefore description will be omitted.

In step S511, it is determined whether one hour has passed since ignition of the lamp DL, and if not the process returns to step S510.

In contrast, if it is determined in step S511 that one hour or more has passed since lamp ignition, then in step S512 a data update is carried out by writing the effective value Vla of the lamp voltage to the lamp status detection circuit 14.

The discharge lamp ballast as described may reduce the frequency of detection of the status of the lamp DL, thereby simplifying the circuit configuration including the storage capacity of the memory.

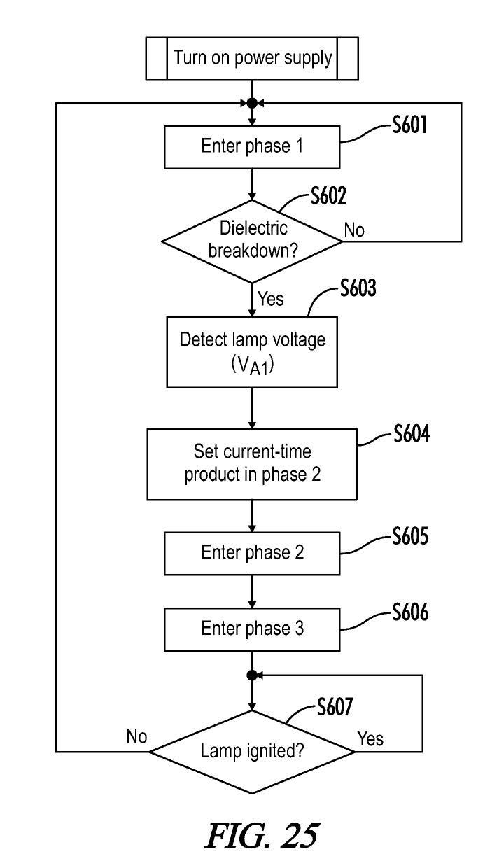

Referring now to FIG. 25, a high pressure discharge lamp ballast includes a lamp status detection circuit 14 which detects and stores, when the lamp DL is turned on, an electrical startup characteristic after the dielectric breakdown.

The control circuit 15 reads the electrical startup characteristic from the lamp status detection circuit 14, determines a current-time product in phase 2 in accordance with the electrical startup characteristic, and controls the amount of power supplied to the lamp DL based on the determined current-time product.

In general, the electrical startup characteristic regards an individual difference caused by impurities in the high pressure discharge lamp tube or other factors. A high pressure discharge lamp which includes a large amount of impurities tends to have a high discharge maintaining voltage and also a high lamp voltage at the time of starting. The ballast in various embodiments may utilize this nature in controlling the amount of power supplied to the lamp DL, in order to improve the stability of the lamp DL during discharge.

Referring again to FIG. 25, after the power supply is turned on, in step S601, phase 1 of the startup sequence described above is executed to determine whether a dielectric breakdown occurs in the lamp DL (step S602).

If it is determined in the procedure in step S602 that no dielectric breakdown occurs in the lamp DL, the method returns to step S601 and repeats.

In contrast, if it is determined in step S602 that a dielectric breakdown occurs in the lamp DL, the lamp status detection circuit 14 detects a lamp voltage VA1 during startup of the lamp DL (step S603).

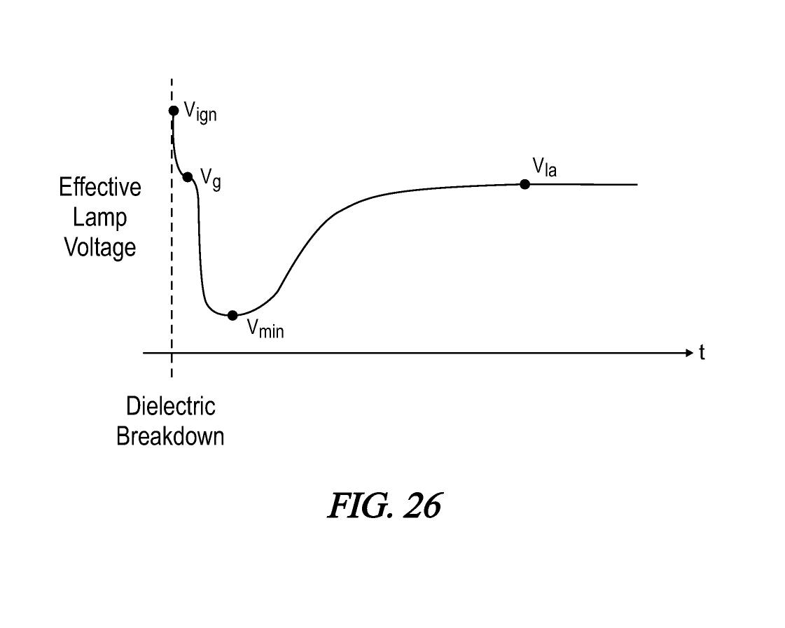

FIG. 26 shows an example of the lamp voltage VA1 to be detected, including a minimum voltage Vmin, a dielectric breakdown voltage Vign, and a voltage Vg in glow discharge. For detection of the minimum voltage Vmin, a voltage across the lamp DL is divided by a resistor and sampled by a microcomputer or other means. For detection of the voltage Vg during glow discharge, a lamp voltage is measured at the time when a lamp current ILA is extremely small or, for example, at approximately 10 mA.

Returning to FIG. 25, in step S604 a current-time product of the lamp in phase 2 is determined in accordance with the detected lamp voltage VA1.

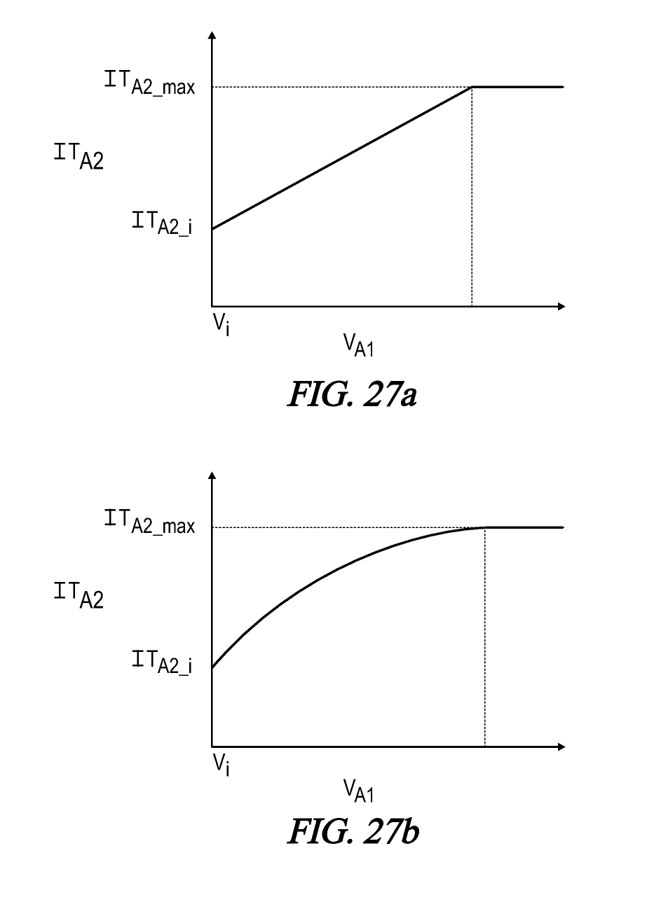

A current-time product established in phase 2 may be adjusted in accordance with the lamp voltage VA1. FIG. 27 shows examples where the current-time product ITA2 determined in phase 2 is increased in accordance with the lamp voltage VA1, wherein FIG. 27a shows a linear increase and FIG. 27b shows a curved increase.

In step S605, under the control of the control circuit 15, phase 2 of the startup sequence described above is executed based on the determined current-time product, and phase 3 is executed in the following step S506.

Next, an operation is conducted to determine whether the lamp DL has been ignited (step S607), and if not the process returns to step S601.

Note that the method described above is advantageous in that an individual difference of the lamp can be obtained without requiring a memory component in the lamp status detection circuit 14. However, if the electrical characteristic is detected before phase 2 in the starting sequence, it is impossible to detect the electrical characteristic after phase 2. For example, at a time when the minimum voltage Vmin as shown in FIG. 26 is to be measured, the lamp voltage is not small enough in phase 1, resulting in measurement of a value higher than the actual minimum voltage Vmin.

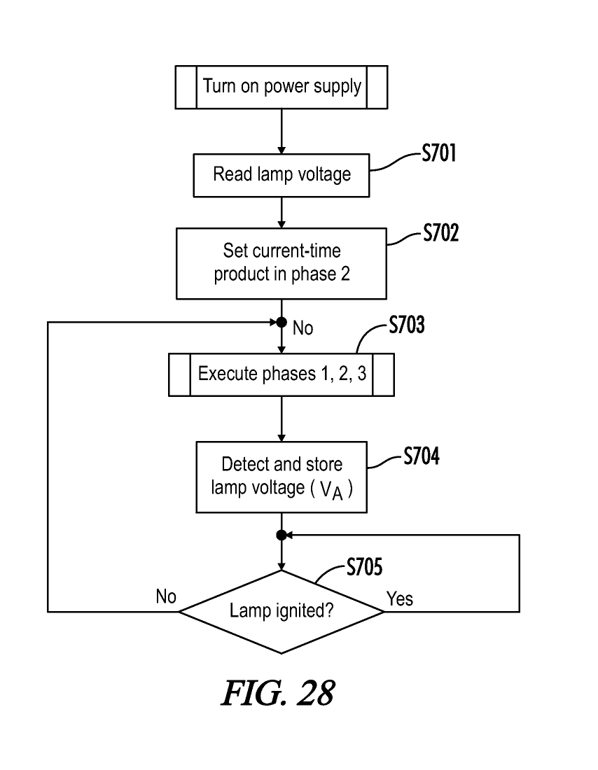

This problem can be resolved in an embodiment as shown in FIG. 28. After the power supply is turned on, in step S701 the lamp voltage VA stored in advance is read from a memory component of the lamp status detection circuit 14.

Next, the current-time product of the lamp in phase 2 is determined in accordance with the stored lamp voltage VA.

In the following step S703, the phases 1 to 3 of the startup sequence are executed as a sub-routine as described above.

Then the lamp voltage VA is detected and stored in the memory of the lamp status detection circuit 14 (step S704), followed by executing the operation to determine whether the lamp DL has been ignited or otherwise remains lit (step S705).

Thus, the electrical characteristic of the lamp DL previously observed, between ignition of the lamp DL to its stable discharge, may be detected and stored in the memory of the lamp lighting state 14 so that when the lamp DL starts up again, the amount of power supplied to the high pressure discharge lamp in phase 2 may also be determined in accordance with the stored electrical characteristic.

In general, if a tube of a high pressure discharge lamp is contaminated with, for example, water as an impurity, the water separates into hydrogen and oxygen. It is generally accepted that the hydrogen gradually leaves outside the tube in the course of operating of the high pressure discharge lamp and is completely eliminated in approximately 100 hours of operation. However, the oxygen remains in the tube and gradually combines with fluorescent material on the tube wall of the high pressure discharge lamp, thereby causing deterioration in the ability of the high pressure discharge lamp to ignite.

This problem may be solved by detecting and storing an electrical characteristic as previously described within approximately 100 hours of first powering the high pressure discharge lamp, and establishing after the 100 hours have elapsed a current-time product in phase 2 in accordance with the stored electrical characteristic in order to control the amount of power supplied to the high pressure discharge lamp.

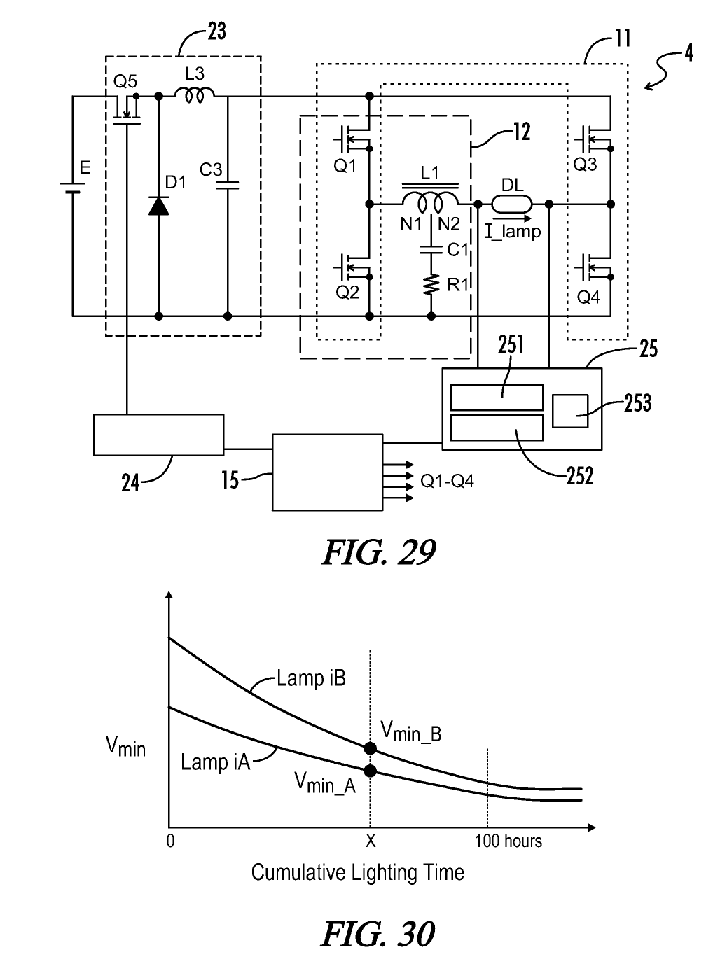

Referring now to FIG. 29, in another embodiment a high pressure discharge lamp ballast 4 includes a lamp status detection circuit 25 in place of the lamp status detection circuit 14 previously described in relation to the embodiment shown in FIG. 9. The lamp status detection circuit 25 includes a cumulative lighting time counter 251, a lamp voltage detection circuit 252, and a storage circuit 253 such as for example an integrated memory.

The cumulative lighting time counter 251 constantly counts the period of time in which the lamp DL is powered and produces a light output, and stores a value corresponding to the time in the storage circuit 253. The stored value is maintained even if the power supply to the ballast is turned off.

The lamp voltage detection circuit 252 detects a lamp electrical characteristic within a predetermined cumulative lighting period of time after installing the lamp DL and stores the lamp electrical characteristic in the storage circuit 253. The stored lamp electrical characteristic is maintained until the lamp DL is replaced. The lamp electrical characteristic in various embodiments may refer to a minimum lamp voltage Vmin detected during the period from dielectric breakdown of the lamp DL to the starting of phase 2.

With reference to FIG. 30, 100 hours may be used as an example of the predetermined cumulative lighting time. In the example shown, the minimum lamp voltage Vmin decreases with elapsing of the cumulative lighting time X. Also, the minimum lamp voltage Vmin may vary depending on the type of high pressure discharge lamp. In FIG. 30, dots indicate minimum lamp voltages Vmin_A and Vmin_B respectively for high pressure discharge lamps A and B at time X, which is within 100 hours of cumulative lighting time.

The lamp electrical characteristic to be detected is not limited to the minimum lamp voltage Vmin, and other examples may without limitation include the dielectric breakdown voltage Vign and the voltage Vg during glow discharge of a lamp as shown in FIG. 26, the lamp voltage effective value Vls during steady-state lighting, and even the re-ignition voltage Vp.

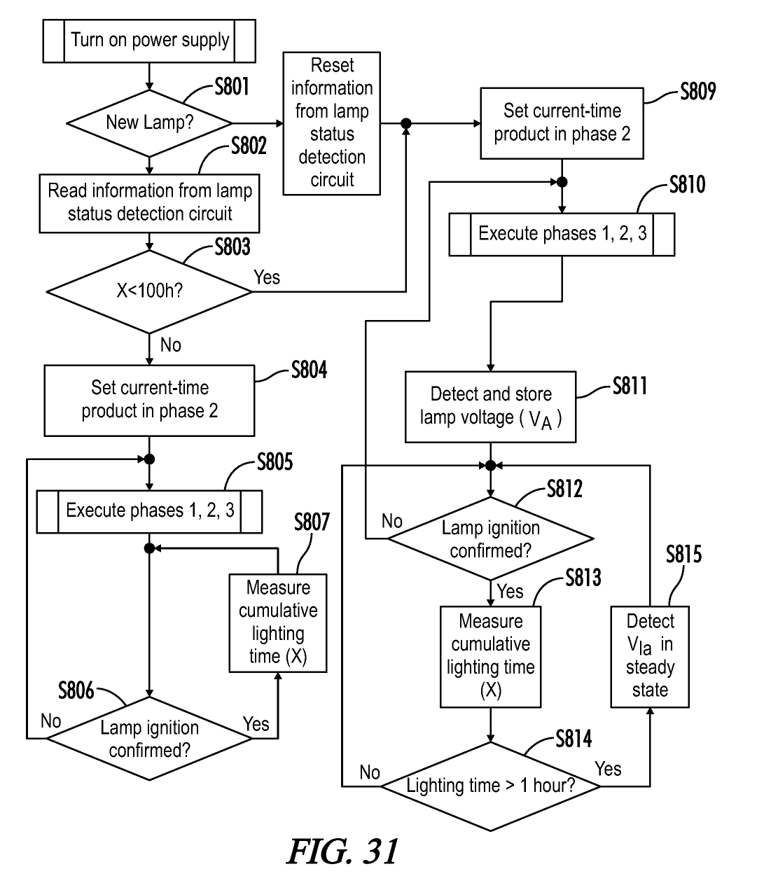

Referring to FIG. 31, an embodiment of an operation of the starting sequence in the high pressure discharge lamp ballast as shown in FIG. 29 may be described. After the power supply is turned on, it is determined in step S501 whether the previously installed high pressure discharge lamp DL is still in use or has been replaced. If it is determined the previous high pressure discharge lamp DL is still in place, the cumulative lighting time X, the minimum lamp voltage Vmin, and the lamp voltage effective value Vla are read from the lamp status detection circuit 24.

Next, it is determined whether the cumulative lighting time X that was read is shorter than 100 hours (step S803).

If the result from step S803 shows that the cumulative lighting time X is 100 hours or more, the current-time product ITA2 of the lamp may be established in phase 2 in accordance with the minimum lamp voltage Vmin that was read (step S804).

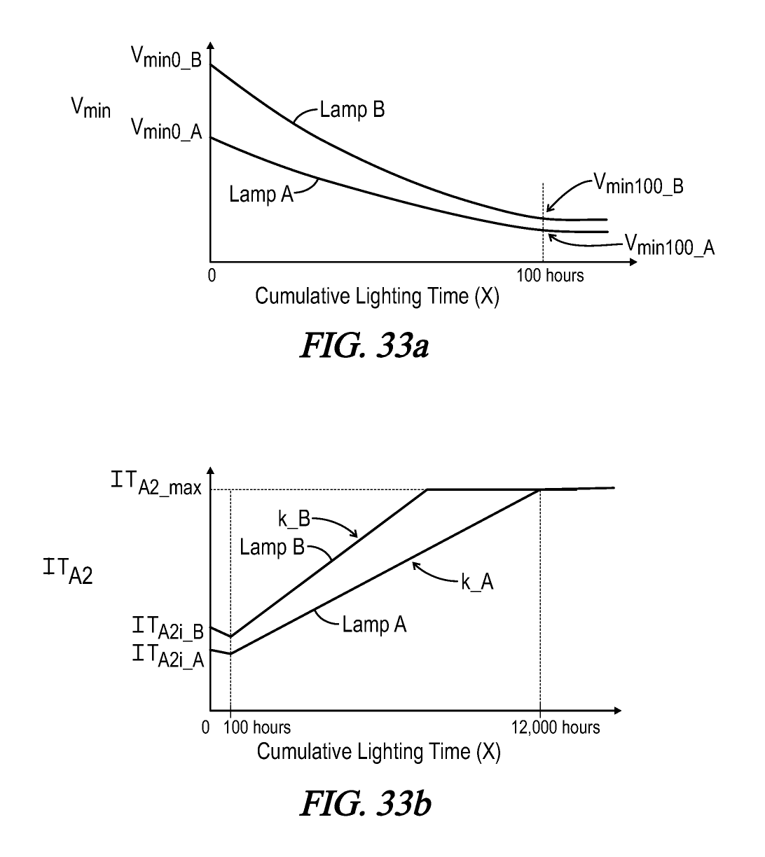

The minimum lamp voltage Vmin may be calculated as, for example, initial Vmin [0-100H], which is an average value of Vmin at X=0 (Vmin0) and Vmin at X=100 hours (Vmin100) as shown in FIG. 33 and stored in the storage circuit 243 of the lamp status detection circuit 24. This value may be maintained until the high pressure discharge lamp is replaced with a new lamp.

During a subsequent lamp starting operation, the current-time product ITA2 may then be established in phase 2 in accordance with the value of the stored initial Vmin [0-100H]. In this case, ITA2 in phase 2 is increased in accordance with a larger value of Vmin [0-100H].

Note that the above-described Vmin [0-100H] is not limited to the average value of Vmin obtained at two different points of time, X=0 and X=100 hours, and may also be an average value of a continuous distribution when X is 0 to 100 hours. It is also possible to use a Vmin obtained at one or more predetermined times X1 such as 0 hours and 50 hours.

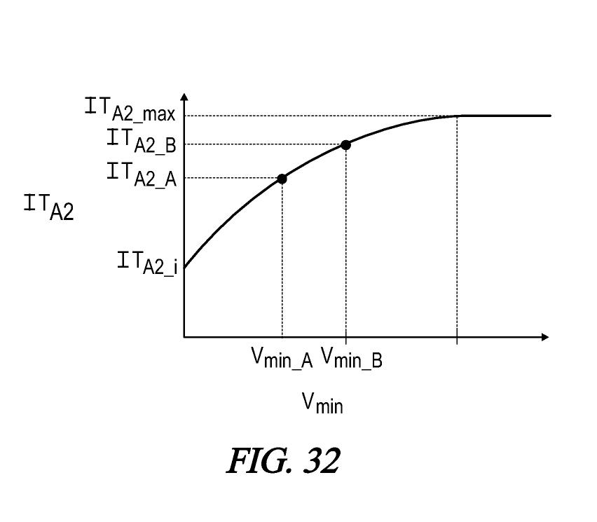

The current-time product ITA2 may be increased in accordance with a larger value of the minimum lamp value Vmin in each lamp as shown in FIG. 32.

In step S805, the control circuit 15 executes phases 1 to 3 of the starting sequence described above, for example as a sub-routine based on the established current-time product.

In step S806, an operation is executed to determine whether the lamp DL has been ignited or is otherwise irradiating light, and if it is determined that no light is being produced, the process will return to step S805 to repeat phases 1 to 3.

In contrast, if it is determined in step S806 that light is being produced from the lamp DL, then in step S807 the cumulative lighting time counter 241 counts or otherwise measures/obtains the cumulative lighting time X of the lamp status detection circuit 24.

Returning to step S801, if it is determined that the high pressure discharge lamp DL has been replaced, the cumulative lighting time X, the minimum lamp voltage Vmin, and the lamp voltage effective value Vla that are stored in the lamp status detection circuit 24 are reset (step S808).

Then, in step S809, the current-time product ITA2 of the lamp in phase 2 is established in accordance with the minimum lamp voltage Vmin. This procedure is substantially similar to that when the cumulative lighting time X is within 100 hours in previously described step S803.

In step S810, phases 1 to 3 of the starting sequence are executed by the control circuit, for example as a sub-routine based on the established current-time product.

Next, the lamp voltage detection circuit 242 of the lamp status detection circuit 24 detects the lamp voltage VA, and it is stored in the storage circuit 243.

In step S812, an operation is executed to determine whether the lamp DL has been ignited or is otherwise irradiating light, and if it is determined that no light is being produced, the process will return to step S810 to repeat phases 1 to 3.

In contrast, if it is determined in step S812 that light is being produced from the lamp DL, then in step S813 the cumulative lighting time counter 241 of the lamp status detection circuit 24 counts or otherwise measures/obtains the cumulative lighting time X so as to determine whether one hour has passed since ignition of the lamp DL (step S814).

If the result in step S814 shows that one hour has not passed yet, the process returns to step S812.

If it is determined in step S814 that one hour has in fact passed since ignition of the lamp, then in step S815 the lamp voltage detection circuit 242 of the lamp status detection circuit 24 detects the lamp voltage effective value Vla in what may be presumed as steady-state operation, followed by returning to step S812.

A high pressure discharge lamp ballast as described above establishes a current-time product ITA2 of the lamp in phase 2 of the starting sequence in accordance with a minimum lamp voltage for dielectric breakdown as individual information with regards to the lamp, and controls the amount of power supplied to the high pressure discharge lamp DL in phase 2 on the basis of the established current-time product ITA2. This permits optimum filament heating in phase 2 regardless of the individual properties of the high pressure discharge lamp such as for example the amount of impurity contaminating the lamp. As a result, stable discharge may be formed at the time of transition to phase 3.

In another embodiment, a high pressure discharge lamp ballast having a circuit structure substantially as shown in FIG. 29 may differ from previously described embodiments in that a particular characteristic/difference associated with the high pressure discharge lamp which is detected to establish the current-time product ITA2 includes not only the electrical characteristic of the lamp but also the cumulative lighting time.

A lamp voltage detection circuit 243 may detect data regarding the particular characteristic of the high pressure discharge lamp, in an example described herein the minimum lamp voltage Vmin obtained between dielectric breakdown of the lamp DL and the starting of phase 2 when the cumulative lighting time X is less than 100 hours, and store the minimum lamp voltage Vmin in a storage circuit 243. Then, this value is read to establish the current-time product ITA2.

In contrast, where the cumulative lighting time X exceeds 100 hours, the current-time product ITA2 is increased as the cumulative lighting time X is increased. Using a minimum lamp voltage Vmin obtained at a cumulative lighting time X of less than 100 hours and stored in the storage circuit 243, the Vmin [0-100H] of the minimum lamp voltage Vmin is calculated to correct or otherwise re-calculate the current-time product ITA2.

As shown in FIGS. 33a and 33b, the ignition data value Vmin [0-100H] is calculated as an average value of Vmin at X=0 and Vmin at X=100 hours. Then, the gradient or derivative of the current-time product ITA2 relative to the cumulative lighting time X may be corrected or otherwise re-calculated in accordance with the value of Vmin [0-100H].

For example, as further shown in FIG. 33a, the minimum lamp voltages Vmin relative to the cumulative lighting times X of the lamps A and B are such that the lamp B shows a larger value in the range of the cumulative lighting time of from 0 to 100 hours, whereby the lamp B also has a larger Vmin [0-100H] of the minimum lamp voltage Vmin. Thus, the gradient of the current-time product ITA2 relative to the cumulative lighting time X is corrected so as to be larger in the lamp B as shown in FIG. 33b.

Note that the above-described ignition value Vmin [0-100H] is not limited to the average value of Vmin obtained at two points of time, X=zero and X=100 hours, and may also be an average value of Vmin as continuously obtained while X is between 0 to 100 hours. It is also possible to use a Vmin obtained at a predetermined lighting period of time X1 such as for example 0 hours and 50 hours.

A high pressure discharge lamp ballast so described may establish the current-time product ITA2 of the lamp in phase 2 of the starting sequence in accordance with a minimum lamp voltage after dielectric breakdown and the cumulative lighting time of the lamp, and control the amount of power supplied to the high pressure discharge lamp DL in phase 2 on the basis of the established current-time product ITA2. This permits optimum filament heating in phase 2 regardless of individual characteristics and the cumulative lighting time of the high pressure discharge lamp. As a result, stable discharge may be formed at the time of transition to phase 3.

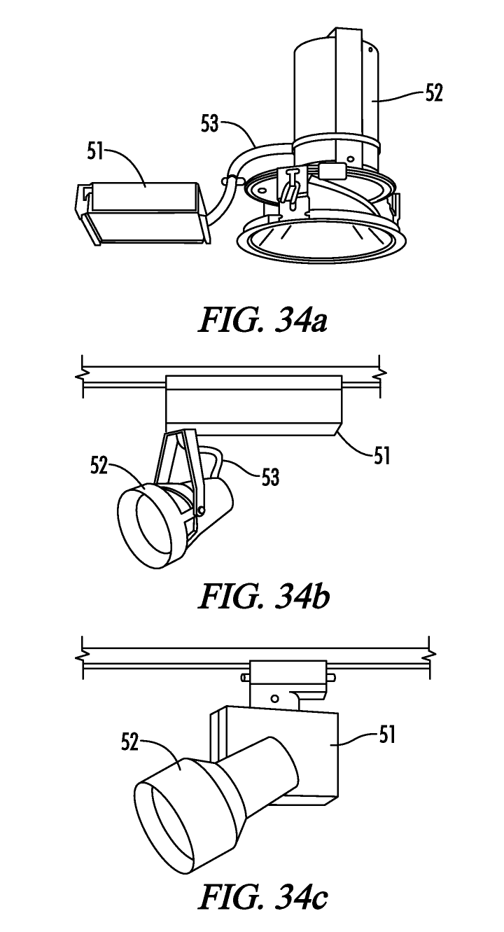

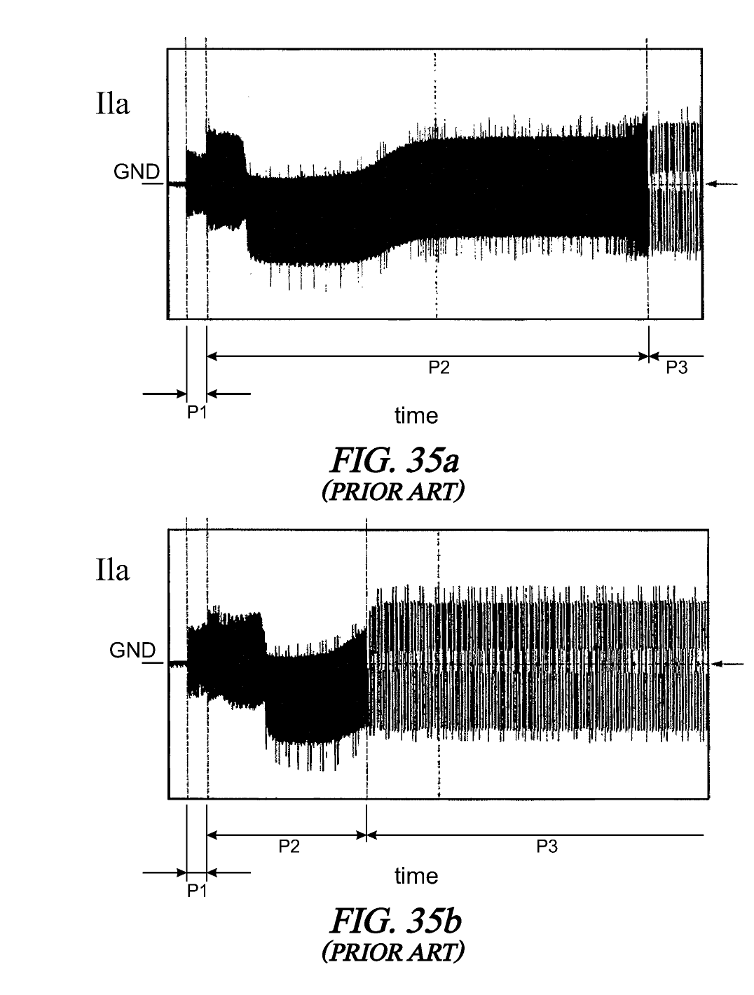

In various embodiments, illumination fixtures may be provided which include and make use of a high pressure discharge lamp ballast configured and operated in accordance with the present invention. Such an illumination fixture may be a downlight as shown in FIG. 34a, or for example may be a spotlight as shown in FIGS. 34b and 34c.

Each of the illumination fixtures shown in FIGS. 34a to 34c include a ballast housing 51 in which a high pressure discharge lamp may be stored, and a lamp housing 52 storing the lamp DL and a lamp socket. Each of the illumination fixtures shown in FIGS. 34a and 34b further includes a power supply line 53 for electrically connecting an embodiment of a high pressure discharge lamp ballast of the present invention and the lamp socket to each other.

It is also anticipated that an illumination system may be constructed by using a plurality of the illumination fixtures shown in any one or more of FIGS. 34a to 34c along with a control circuit for controlling each of the illumination fixtures.

Such illumination fixtures and illumination system as shown and described may make stable ignition and operation possible regardless of the cumulative lighting time of the one or more lamps included in the system, and further regardless of various additional individual characteristics associated with the lamps.

Thus, although there have been described particular embodiments of the present invention of a new and useful High Pressure Discharge Lamp Ballast with Adaptive Filament Heating Control Based on Lamp Age, it is not intended that such references be construed as limitations upon the scope of this invention except as set forth in the following claims.

What is claimed is:

1. A high pressure discharge lamp ballast comprising:
a DC-AC power converter;
a starting circuit effective to generate a high voltage for dielectric breakdown in a high pressure discharge lamp, the starting circuit and the lamp coupled to output terminals of the DC-AC power converter;
a lamp parameter detection circuit; and
a control circuit effective to control the DC-AC power converter, the control circuit configured to determine a power output parameter for controlling the output power provided by the DC-AC power converter to the high pressure discharge lamp in a filament heating period after dielectric breakdown of the lamp,
wherein the power output parameters is determined in accordance with one or more lamp parameters detected by the lamp status detection circuit.

2. The lamp ballast of claim 1, wherein the lamp parameters comprise one or more of a cumulative lighting time of the high pressure discharge lamp and an electrical characteristic of the high pressure discharge lamp.

3. The lamp ballast of claim 2, wherein the electrical characteristic is a difference between an initial detected value of an electrical characteristic at the time of installing the high pressure discharge lamp and a recently detected value of the electrical characteristic.

4. The lamp ballast of claim 3, wherein the electrical characteristic is detected during a predetermined cumulative lighting time measured from installation of the high pressure discharge lamp.

5. The lamp ballast of claim 4, wherein the electrical characteristic is detected between a dielectric breakdown of the high pressure discharge lamp and transition from the filament heating period to a steady-state period.

6. The lamp ballast of claim 5, wherein the electrical characteristic is a minimum lamp voltage.

7. The lamp ballast of claim 5, wherein the electrical characteristic is an effective value of a lamp voltage detected during the steady-state period.

8. The lamp ballast of claim 5, wherein the electrical characteristic is a re-ignition voltage detected in the steady-state period.

9. The lamp ballast of claim 1, wherein the power output parameter is a value of a current supplied to the high pressure discharge lamp.

10. The lamp ballast of claim 1, wherein the power output parameter is a determined duration of the filament heating period.

11. The lamp ballast of claim 1, wherein the power output parameter is a current-time product representing a value of a current supplied to the high pressure discharge lamp multiplied by a determined duration of the filament heating period.

12. A method of adaptive control for a high pressure discharge lamp ballast, the ballast comprising an inverter, a lamp parameter detection circuit, and a control circuit effective to control a power output from the inverter to a high pressure discharge lamp, the method comprising:
reading a cumulative lamp parameter from the lamp parameter detection circuit, the lamp parameter comprising either a cumulative lighting time for the lamp or a cumulative lamp ignition count;
setting a power output parameter for the power converter based on the cumulative lamp parameter;
controlling the power converter to provide an output power to the lamp corresponding to the power output parameter during a filament heating period which begins after dielectric breakdown of the lamp;
terminating the filament heating period and entering a steady-state period, wherein the control circuit controls the power converter to decrease an operating frequency and maintain a stable light output from the lamp.

13. The method of claim 12, the power output parameter comprising one of a current output to the lamp, a determined duration of the filament heating period, or a current-time product comprising a current output to the lamp multiplied by a determined duration of the filament heating period.

14. The method of claim 13, further comprising:
reading an electrical characteristic associated with the lamp from the lamp parameter detection circuit;
detecting a new value for the electrical characteristic and storing the new value for the electrical characteristic in the lamp parameter detection circuit; and
wherein the step of setting a power output parameter for the power converter based on the cumulative lamp parameter further comprises setting a power output parameter for the power converter based on the cumulative lamp parameter and the electrical characteristic read from the lamp parameter detection circuit.

15. The method of claim 14, wherein the electrical characteristic comprises one or more of a minimum lamp voltage during the filament heating period, an effective lamp voltage during the steady-state period, and a re-ignition voltage during the steady-state period.

16. The method of claim 15, wherein the electrical characteristic comprises a difference between an initial detected electrical characteristic and a recently detected electrical characteristic.

17. An illumination system comprising:
one or more illumination fixtures, each illumination fixture comprising
a ballast housing,
a high pressure discharge lamp ballast positioned within the ballast housing,
a lamp housing mechanically coupled to the ballast housing and electrically coupled to the discharge lamp ballast, and containing a high pressure discharge lamp, and
a control device for controlling each of the one or more illumination fixtures;
the lamp ballast further comprising
a DC-AC power converter,
a lamp parameter detection circuit, and
a control circuit effective to control the power converter, the control circuit configured to determine a power output parameter to the high pressure discharge lamp in a filament heating period after dielectric breakdown of the lamp; and
wherein the power output parameter is determined in accordance with one or more lamp parameters detected by the lamp status detection circuit.

18. The illumination system of claim 17, wherein the lamp parameters comprise one or more of a cumulative lighting time of the high pressure discharge lamp and an electrical characteristic of the high pressure discharge lamp.

19. The illumination system of claim 18, wherein the power output parameter comprises one of a current output to the lamp, a determined duration of the filament heating period, or a current-time product comprising a current output to the lamp multiplied by a determined duration of the filament heating period.

20. The illumination system of claim 19, wherein the electrical characteristic comprises one or more of a minimum lamp voltage during the filament heating period, an effective lamp voltage during a steady-state period following termination of the filament heating period, and a re-ignition voltage during the steady-state period.
